(19) United States
(12) Patent Application Publication
(10) Pub. No.: US 2023/0202606 A1
(43) Pub. Date: Jun. 29, 2023

(54) CONTROL DEVICE FOR HUMAN-POWERED VEHICLE AND AIR-PRESSURE ADJUSTING DEVICE

(71) Applicant: Shimano Inc., Osaka (JP)

(72) Inventors: Satoshi SHAHANA, Osaka (JP); Akinobu SUGIMOTO, Osaka (JP); Akira INOUE, Osaka (JP); Hitoshi TAKAYAMA, Osaka (JP)

(21) Appl. No.: 18/085,915

(22) Filed: Dec. 21, 2022

(30) Foreign Application Priority Data
Dec. 24, 2021 (JP) 2021-210300
Sep. 27, 2022 (JP) 2022-153471

(51) Int. Cl. B62J 45/20; B62J 1/10; B62M 6/50

(52) U.S. Cl. CPC B62J 45/20; B62J 1/10; B62M 6/50

(57) ABSTRACT

A control device is provided to a human-powered vehicle. The control device includes an electronic controller. The electronic controller is configured to control an air pressure of a tire provided to the human-powered vehicle, based on at least one of a roughness of a road surface on which the human-powered vehicle is traveling or will travel, a slope state related to an advancing direction of the human-powered vehicle, a wet state of a road surface, a traveling state of the human-powered vehicle, and a state of a component mounted on the human-powered vehicle.

### CROSS-REFERENCE TO RELATED APPLICATIONS

This application claims priority to Japanese Patent Application No. 2021-210300, filed on Dec. 24, 2021, and Japanese Patent Application No. 2022-153471, filed on Sep. 27, 2022. The entire disclosures of Japanese Patent Application No. 2021-210300 and Japanese Patent Application No. 2022-153471 are hereby incorporated herein by reference.

### BACKGROUND

### Technical Field

The present invention generally relates to a control device for a human-powered vehicle and an air-pressure adjusting device.

### Background Information

There has been known an air injection device that automatically injects air into a tire of a human-powered vehicle during traveling. U.S. Pat. No. 7,059,372 (Patent Literature 1) discloses one example of a conventional air injection device.

### SUMMARY

The control device and the air-pressure adjusting device of the present disclosure have been made to solve the above problem. One object of the present disclosure is to provide a control device for a human-powered vehicle and an air-pressure adjusting device capable of appropriately controlling an air pressure of a tire.

A control device for a human-powered vehicle according to a first aspect of the present disclosure includes: an electronic controller that is configured to control an air pressure of a tire provided to a human-powered vehicle based on at least one of a roughness of a road surface on which the human-powered vehicle is traveling or will travel, a slope state related to an advancing direction of the human-powered vehicle, a wet state of the road surface, a traveling state of the human-powered vehicle, and a state of a component mounted on the human-powered vehicle.

The control device according to the first aspect is capable of appropriately controlling an air pressure of a tire in accordance with at least one of a road-surface-roughness, a slope state, a wet state of a road surface, a traveling state, and a state of a component. The control device is capable of automatically adjusting an air pressure of a tire in accordance with at least one of a road-surface-roughness, a slope state, a wet state of a road surface, a traveling speed, and a state of a component.

In the control device of a second aspect according to the first aspect, the electronic controller is further configured to control the air pressure of the tire based on a detection result of a road-surface-roughness detecting unit configured to detect the roughness of the road surface on which the human-powered vehicle is traveling or will travel.

The control device according to the second aspect is capable of appropriately controlling an air pressure of a tire in accordance with a road-surface-roughness. The control device is capable of automatically adjusting an air pressure of a tire in accordance with a road-surface-roughness.

In the control device of a third aspect according to the second aspect, the electronic controller is further configured to reduce the air pressure of the tire in a case where a roughness of the road surface increases.

The control device according to the third aspect reduces an air pressure of a tire in a case where a road surface is rough, to be able to reduce vibration transmitted to a rider. Thus, the control device is capable of contributing to comfortable traveling of the human-powered vehicle. In a case where a human-powered vehicle is traveling or will travel on a rough road surface, the control device is capable of reducing a wobble of the human-powered vehicle. Thus, in a case where a human-powered vehicle is traveling or will travel on a rough road surface, the control device is capable of improving the safety of a rider. In a case where a human-powered vehicle is traveling or will travel on a rough road surface, an air pressure of a tire reduces, and further a contact area between the road surface and the tire increases. Thus, in a case where a human-powered vehicle is traveling or will travel on a rough road surface, the control device is capable of improving the safety of a rider.

In the control device of a fourth aspect according to the second aspect or the third aspect, the electronic controller is further configured to increase the air pressure of the tire in a case where a roughness of the road surface reduces.

In a case where a road surface is not rough, the control device according to the fourth aspect increases an air pressure of a tire so as to reduce a contact area between a road surface and the tire. Thus, the control device is capable of reducing contact resistance between a road surface and a tire. Thus, the control device is capable of contributing to comfortable traveling of the human-powered vehicle.

In the control device of a fifth aspect according to any one of the second to the fourth aspects, the road-surface-roughness detecting unit includes an acceleration sensor that detects vibration of the traveling human-powered vehicle, and the roughness of the road surface is detected based on the vibration of the human-powered vehicle.

The control device according to the fifth aspect controls an air pressure of a tire in accordance with vibration to be capable of contributing to comfortable traveling of the human-powered vehicle. For example, in a case where vibration is large, the control device reduces an air pressure of a tire to be capable of reducing vibration transmitted to a rider. In a case where vibration is small, the control device increases an air pressure of a tire to be capable of reducing contact resistance between a road surface and the tire. Thus, the control device is capable of contributing to comfortable traveling of the human-powered vehicle.

In a control device of a sixth aspect according to the fifth aspect, the electronic controller is further configured to control the air pressure of the tire based on a value obtained by executing interval average or moving average on the vibration of the human-powered vehicle.

The control device according to the sixth aspect is capable of improving determination accuracy of a road-surface-roughness. For example, the control device is capable of differentiating an impact that occurs in a case where the human-powered vehicle gets over a level difference from a vibration that occurs in a case where a road-surface-roughness becomes rough. Thus, the control device is capable of appropriately controlling an air pressure of a tire in accordance with a road-surface-roughness.

In the control device of a seventh aspect according to the first aspect, the electronic controller that is further configured to control the air pressure of the tire based on a detection result of a slope-state detecting unit configured to detect a slope state related to an advancing direction of the human-powered vehicle.

The control device according to the seventh aspect is capable of automatically adjusting an air pressure of a tire in accordance with a slope state.

In the control device of an eighth aspect according to the seventh aspect, the electronic controller is further configured to increase the air pressure of the tire in a case where an upslope of the road surface is detected as the slope state.

In a case where a human-powered vehicle is traveling or will travel on an upslope, the control device according to the eighth aspect increases an air pressure of a tire to be capable of reducing a contact area between a road surface and the tire. Thus, in a case where a human-powered vehicle is traveling or will travel on an upslope, the control device is capable of reducing contact resistance between a road surface and a tire. In a case where a human-powered vehicle is traveling or will travel on an upslope, the control device is capable of reducing load applied to a rider. Thus, the control device is capable of contributing to comfortable traveling the human-powered vehicle.

In the control device of a ninth aspect according to the seventh aspect or the eighth aspect, the electronic controller is further configured to reduce the air pressure of the tire in a case where a downslope of the road surface is detected as the slope state.

In a case where a human-powered vehicle is traveling or will travel on a downslope and a rider takes a forward bent posture, his/her body weight is applied to arms of the rider, and thus load applied to a front wheel is increased. Thus, for example, a rider easily loses balance due to an impact caused by a level difference, bumps and dips on a road surface, and the like. In a case where a human-powered vehicle is traveling or will travel on a downslope, the control device according to the ninth aspect reduces an air pressure of a tire to be capable of reducing an impact caused by a level difference, bumps and dips on a road surface, and the like. Thus, the control device is capable of improving the safety of a rider.

In the control device of a tenth aspect according to any one of the seventh to the ninth aspects, the slope-state detecting unit detects the slope state based on map information and positional information of the human-powered vehicle that is detected by a reception device of a satellite positioning system.

The control device according to the tenth aspect detects a slope state on the basis of map information and positional information of the human-powered vehicle to be capable of detecting a slope state of a road surface that will be travelled by the human-powered vehicle in addition to a slope state on which the human-powered vehicle is traveling. Thus, the control device is capable of controlling an air pressure of a tire in accordance with a slope state of a road surface that will be travelled by the human-powered vehicle.

In the control device of an eleventh aspect according to any one of the seventh to the ninth aspects, the slope-state detecting unit includes at least one of a slope sensor and an acceleration sensor.

The control device according to the eleventh aspect is capable of improving determination accuracy of a slope state in a case where the human-powered vehicle is traveling.

In the control device of a twelfth aspect according to the first aspect, the electronic controller that is further configured to control the air pressure of the tire based on a detection result of a wet-state detecting unit configured to detect a wet state of a road surface.

The control device according to the twelfth aspect is capable of automatically adjusting an air pressure of a tire in accordance with a wet state of a road surface.

In the control device of a thirteenth aspect according to the twelfth aspect, the electronic controller is further configured to increase the air pressure of the tire in a case where the road surface is detected not to be wet.

In a case where a human-powered vehicle is traveling or will travel on a road surface that is not wet, the control device according to the thirteenth aspect increases an air pressure of a tire to be capable of reducing a contact area between the road surface and the tire. Thus, in a case where a human-powered vehicle is traveling or will travel on a road surface that is not wet, the control device is capable of reducing contact resistance between the road surface and a tire. Thus, the control device is capable of contributing to comfortable traveling of the human-powered vehicle.

In the control device of a fourteenth aspect according to the twelfth aspect or the thirteenth aspect, the electronic controller is further configured to reduce the air pressure of the tire in a case where the road surface is detected to be wet.

In a case where a human-powered vehicle is traveling or will travel on a wet road surface, the control device according to the fourteenth aspect reduces an air pressure of a tire so as to increase a contact area between the road surface and the tire. Thus, in a case where a human-powered vehicle is traveling or will travel on a wet road surface, a control device is capable of reducing occurrence of a slip of the human-powered vehicle. Thus, the control device is capable of improving the safety of a rider.

In the control device of a fifteenth aspect according to any one of the twelfth to the fourteenth aspects, the wet-state detecting unit detects the wet state based on weather information and positional information of the human-powered vehicle that is detected by a reception device of a satellite positioning system.

The control device according to the fifteenth aspect detects a wet state on the basis of weather information and positional information of the human-powered vehicle to be capable of detecting a wet state of wide-range road surfaces. Thus, the control device is capable of controlling an air pressure of a tire in accordance with a wet state of a road surface on which the human-powered vehicle is traveling. The control device is capable of preliminarily controlling an air pressure of a tire in accordance with a wet state of a road surface that will be travelled by the human-powered vehicle.

In the control device of a sixteenth aspect according to any one of the twelfth to the fourteenth aspects, the wet-state detecting unit includes a sensor that detects wetness of a road surface.

The control device according to the sixteenth aspect is capable of improving determination accuracy of a wet state of a road surface in a state where the human-powered vehicle is traveling.

In the control device of a seventeenth aspect according to the first aspect, the electronic controller that is further configured to control the air pressure of the tire based on a detection result of a speed detecting unit configured to detect a traveling speed of the human-powered vehicle.

The control device according to the seventeenth aspect is capable of automatically adjusting an air pressure of a tire in accordance with a traveling speed.

In the control device of an eighteenth aspect according to the seventeenth aspect, the electronic controller is further configured to reduce the air pressure of the tire in a case where the traveling speed increases.

In a state where a traveling speed is large, for example, an impact applied to the human-powered vehicle, which is caused by a level difference, bumps and dips on a road surface, and the like becomes large. Thus, a rider easily loses his/her balance due to an impact caused by a level difference or the like. In a case where a traveling speed of the human-powered vehicle increases, a control device according to the eighteenth aspect reduces an air pressure of a tire to be capable of reducing an impact caused by a level difference, bumps and dips on a road surface, and the like. Thus, the control device is capable of improving the safety of a rider.

In the control device of a nineteenth aspect according to the seventeenth aspect or the eighteenth aspect, the electronic controller is further configured to increase the air pressure of the tire in a case where the traveling speed reduces.

In a case where a traveling speed reduces, the control device according to the nineteenth aspect increases an air pressure of a tire so as to reduce a contact area between a road surface and the tire. Thus, the control device is capable of reducing contact resistance between a road surface and a tire. Thus, the control device is capable of contributing to comfortable traveling of the human-powered vehicle.

In the control device of a twentieth aspect according to the first aspect, the electronic controller that is further configured to control the air pressure of the tire based on a detection result of a component-state detecting unit configured to detect a state of a component mounted on the human-powered vehicle.

The control device according to the twentieth aspect is capable of automatically adjusting an air pressure of a tire in accordance with a state of a component mounted on the human-powered vehicle.

In the control device of a twenty-first aspect according to the twentieth aspect, the component includes a suspension that is attached to a frame to reduce an impact applied from a road surface.

The control device according to the twenty-first aspect is capable of automatically adjusting an air pressure of a tire in accordance with a state of the suspension.

In the control device of a twenty-second aspect according to the twenty-first aspect, the electronic controller is further configured to increase the air pressure of the tire in a case where the suspension is adjusted to weaken a function for reducing the impact.

In a case where a suspension is adjusted to weaken a function for reducing the impact, the control device according to the twenty-second aspect increases an air pressure of a tire so as to reduce a contact area between a road surface and the tire. Thus, the control device is capable of reducing contact resistance between a road surface and a tire. Thus, the control device is capable of contributing to comfortable traveling of the human-powered vehicle.

In the control device of a twenty-third aspect according to the twenty-first aspect or the twenty-second aspect, the electronic controller is further configured to reduce the air pressure of the tire in a case where the suspension is adjusted to improve a function for reducing the impact.

In a case where the suspension is adjusted to improve a function for reducing an impact, there presents possibility that a road surface on which the human-powered vehicle is traveling or will travel is a road surface whose impact is large. In a case where the suspension is adjusted to strengthen a function for reducing an impact, the control device according to the twenty-third aspect reduces an air pressure of a tire to be capable of further reducing an impact from a road surface. Thus, the control device is capable of improving the safety of a rider.

In the control device of a twenty-fourth aspect according to the twentieth aspect, the component includes a seat post that is capable of adjusting a height of a saddle of the human-powered vehicle.

The control device according to the twenty-fourth aspect is capable of automatically adjusting an air pressure of a tire in accordance with a height of the seat post.

In the control device of a twenty-fifth aspect according to the twenty-fourth aspect, the electronic controller is further configured to reduce the air pressure of the tire in a case where a height of the seat post is adjusted to be reduced.

In a case where a height of a seat post is reduced, unstable traveling of a human-powered vehicle is supposed. For example, in a case where a height of a seat post is reduced, a human-powered vehicle that is traveling or will travel on a downslope is supposed. In a case where a height of a seat post is reduced, the control device according to the twenty-fifth aspect reduces an air pressure of a tire to be capable of reducing an impact caused by a level difference on a downslope or the like. Thus, the control device is capable of improving the safety of a rider.

The control device of a twenty-sixth aspect according to the twenty-fourth aspect or the twenty-fifth aspect, the electronic controller is further configured to increase the air pressure of the tire in a case where a height of the seat post is adjusted to be increased.

In a case where a height of the seat post is increased, stabile traveling of the human-powered vehicle is supposed. In a case where a height of the seat post is increased, for example, the human-powered vehicle that is traveling or will travel on an upslope or a flat is supposed. In a case where a height of the seat post is increased, the control device according to the twenty-fifth aspect increases an air pressure of a tire so as to reduce contact resistance between a road surface and the tire. Thus, the control device is capable of contributing to comfortable traveling of the human-powered vehicle.

In the control device a twenty-seventh aspect according to the twentieth aspect, the component includes a transmission device configured to change a transmission ratio in accordance with a traveling state of the human-powered vehicle.

The control device according to the twenty-seventh aspect is capable of automatically adjusting an air pressure of a tire in accordance with a state of a transmission device that changes a transmission ratio thereof in accordance with a traveling state of the human-powered vehicle.

In the control device a twenty-eighth aspect according to the twenty-seventh aspect, the electronic controller is further configured to reduce the air pressure of the tire in a case where a change in a transmission ratio according to a traveling state of the human-powered vehicle is not allowed.

In a case where change in a transmission ratio according to a traveling state of the human-powered vehicle is not allowed, traveling on a downslope, a rough road surface, or a road surface whose load for a rider is large is supposed. In a case where change in a transmission ratio according to a traveling state of the human-powered vehicle is not allowed, a control device according to the twenty-eighth aspect reduces an air pressure of a tire to be capable of reducing an impact due to a level difference on a downslope, for example. Thus, the control device is capable of improving the safety of a rider.

In the control device of a twenty-ninth aspect according to the twenty-seventh aspect or the twenty-eighth aspect, the electronic controller is further configured to increase the air pressure of the tire in a case where a change in a transmission ratio according to a traveling state of the human-powered vehicle is allowed.

In a case where change in a transmission ratio according to a traveling state of the human-powered vehicle is allowed and traveling on a downslope, a rough road surface, a road surface whose load for a rider is large, or the like is not supposed, the control device according to the twenty-ninth aspect increases an air pressure of a tire. Thus, the control device is capable of reducing contact resistance between the road surface and the tire. Thus, the control device is capable of contributing to comfortable traveling of the human-powered vehicle.

In the control device of a thirtieth aspect according to the twentieth aspect, the component includes an electric drive unit configured to assist in propulsion of the human-powered vehicle by using a motor.

The control device according to the thirtieth aspect is capable of automatically adjusting an air pressure of a tire in accordance with a state of the electric drive unit.

In the control device of a thirty-first aspect according to the thirtieth aspect, the electronic controller is further configured to increase the air pressure of the tire in a case where an assistance operation by the electric drive unit is not allowed.

In a case where an assistance operation by the electric drive unit is not allowed and thus load for a rider is large, the control device according to the thirty-first aspect increases an air pressure of a tire to be capable of reducing contact resistance between a road surface and the tire. Thus, the control device is capable of reducing load for a rider. In a case where the assisting operation is not allowed, a case of a flat road surface or a road surface that is not rough, in each of which load for a rider is small, is supposed. Thus, the control device is capable of contributing to comfortable traveling of the human-powered vehicle. In a case where an assistance operation by the electric drive unit is not allowed, the control device prevents increase in load for a rider to be capable of contributing to comfortable traveling of the human-powered vehicle.

In the control device of a thirty-second aspect according to the thirtieth aspect or the thirty-first aspect, the electronic controller is further configured to reduce the air pressure of the tire in a case where an assistance operation by the electric drive unit is allowed.

For example, in a case where an assistance operation by the electric drive unit is allowed and thus there presents possibility that a traveling speed of the human-powered vehicle increases, the control device according to the thirty-second aspect reduces an air pressure of a tire. Thus, in a case where a traveling speed is increased and thus an impact from road surface is increased, the control device reduces an air pressure of a tire to be capable of reducing an impact from a road surface. In a case where an assistance operation is allowed, a case of an upslope or a rough road surface, in each of which load for a rider is large, is supposed. Thus, the control device is capable of improving the safety of a rider. In a case where an assistance operation by the electric drive unit is allowed, the control device prioritizes the stability of traveling over load for a rider to be capable of contributing to comfortable traveling of the human-powered vehicle.

In the control device of a thirty-third aspect according to any one of the thirtieth to the thirty-second aspects, the electronic controller is further configured to increase the air pressure of the tire in a case where a strength of assistance applied from the electric drive unit is adjusted from a large state into a small state.

In a case where load for a rider increases, the control device according to the thirty-third aspect increases an air pressure of a tire to be capable of reducing contact resistance between a road surface and the tire. Thus, the control device is capable of reducing load for a rider. Thus, the control device is capable of contributing to comfortable traveling of the human-powered vehicle.

In the control device of a thirty-fourth aspect according to any one of the thirtieth to the thirty-third aspects, the electronic controller is further configured to reduce the air pressure of the tire in a case where a strength of assistance applied from the electric drive unit is adjusted from a small state into a large state.

In a case where there presents possibility that a traveling speed of the human-powered vehicle increases, the control device according to the thirty-fourth aspect reduces an air pressure of a tire. Thus, in a case where a traveling speed is increased and thus an impact from a road surface is increased, the control device reduces an air pressure of a tire to be capable of reducing an impact from a road surface. Thus, the control device is capable of improving the safety of a rider. In a case where a strength of assistance applied from the electric drive unit is adjusted into a large state, the control device prioritizes the stability of traveling over load for a rider to be capable of contributing to comfortable traveling of the human-powered vehicle.

A control device for a human-powered vehicle according to a thirty-fifth aspect includes: an electronic controller that is configured to control an air pressure of a tire provided to a human-powered vehicle, based on at least one detection result of a state of a road surface on which the human-powered vehicle is traveling or will travel, a traveling state of the human-powered vehicle, and a state of a component of the human-powered vehicle. The electronic controller is further configured to control the air pressure of the tire based on a detection result having a high priority.

In a case where a plurality of detection results includes a result for increasing an air pressure of a tire and a result for reducing an air pressure of a tire, the control device according to the thirty-fifth aspect controls an air pressure of the tire on the basis of a detection result having a high priority. Thus, the control device is capable of further appropriately controlling an air pressure of a tire.

A control device for a human-powered vehicle according to a thirty-sixth aspect includes: an electronic controller that is configured to control an air pressure of a tire provided to a human-powered vehicle, based on at least one detection result of a state of a road surface on which the human-powered vehicle is traveling or will travel, a traveling state of the human-powered vehicle, and a state of a component of the human-powered vehicle. The electronic controller is further configured to control the air pressure of the tire in accordance with a detection result in which the air pressure of the tire is reduced in priority to a detection result in which the air pressure of the tire is increased.

In a case where a plurality of detection results includes a result for increasing an air pressure of a tire and a result for reducing an air pressure of a tire, the control device according to the thirty-sixth aspect reduces an air pressure of the tire to be capable of improving the safety of a rider.

In the control device of a thirty-seventh aspect according to any one of the first to the thirty-fifth aspects, the electronic controller that is further configured to calculate an adjustment value of the air pressure of the tire by using an estimation model based on at least one of a roughness of a road surface on which the human-powered vehicle is traveling or will travel, a slope state related to an advancing direction of the human-powered vehicle, a wet state of the road surface, a traveling state of the human-powered vehicle, and a state of the component mounted on the human-powered vehicle. The electronic controller is further configured to control the air pressure of the tire based on the calculated adjustment value.

The control device according to the thirty-seventh aspect calculates an adjustment value of an air pressure of a tire by using an estimation model to be capable of calculating an air pressure that is appropriately to the tire. The control device is capable of further preferably controlling an air pressure of a tire.

In the control device of a thirty-eighth aspect according to any one of the first to the thirty-fifth aspects, the electronic controller is further configured to: calculate an adjustment value of the air pressure of the tire by using an estimation model based on the detection result; and control the air pressure of the tire based on the calculated adjustment value.

The control device according to the thirty-eighth aspect calculates an adjustment value of an air pressure of a tire by using an estimation model to be capable of calculating an air pressure that is appropriate for the tire. The control device is capable of further preferably controlling an air pressure of a tire.

A control system comprises the control device of a thirty-ninth aspect according to any one of the first to the thirty-eighth aspects further includes: an air-pressure adjusting device configured to adjust the air pressure of the tire. In a state where the human-powered vehicle is not traveling, the electronic controller is further configured to: acquire information related to at least one of a state of the road surface on which the human-powered vehicle will travel, a traveling state of the human-powered vehicle, and a state of the component mounted on the human-powered vehicle; calculate an adjustment value of the air pressure of the tire; and adjust the air pressure of the tire.

In a state where a human-powered vehicle is not traveling, the control device according to the thirty-ninth aspect is capable of preferably adjusting an air pressure of a tire in accordance with information related to at least one of a state of a road surface on which the human-powered vehicle will travel, a traveling state of the human-powered vehicle, and a state of the component mounted on the human-powered vehicle. In a state where a human-powered vehicle is not traveling, the control device is capable of changing an air pressure of a tire, and thus in a case where the human-powered vehicle is traveling, the control device reduces change in an air pressure of the tire to be capable of reducing load of the control device during traveling.

An air-pressure adjusting device according to a fortieth aspect of the present disclosure is configured to adjust an air pressure of a tire of a human-powered vehicle. The air-pressure adjusting device comprises a control device configured to control the air pressure of the tire. In a state where the human-powered vehicle is not traveling, the control device is configured to: acquire information related to at least one of a state of a road surface on which the human-powered vehicle will travel, a traveling state of the human-powered vehicle, and a state of a component mounted on the human-powered vehicle; calculate an adjustment value of the air pressure of the tire; and adjust the air pressure of the tire.

In a state where a human-powered vehicle is not traveling, the air-pressure adjusting device according to the fortieth aspect is capable of preferably adjusting an air pressure of a tire in accordance with information related to at least one of a state of a road surface on which the human-powered vehicle will travel, a traveling state of the human-powered vehicle, and a state of a component mounted on the human-powered vehicle. In a state where a human-powered vehicle is not traveling, the control device is capable of changing an air pressure of a tire and further capable of reducing change in an air pressure of the tire during traveling of the human-powered vehicle, so that it is possible to reduce load of the control device during traveling.

An air-pressure adjusting device of a forty-first aspect according to the fortieth aspect, the air-pressure adjusting device is configured to be detachably provided to the human-powered vehicle.

For example, the air-pressure adjusting device according to the forty-first aspect is attached a human-powered vehicle before traveling of the human-powered vehicle, and is detached from the human-powered vehicle after an air pressure of a tire is preferably adjusted. The air-pressure adjusting device is capable of adjusting an air pressure of a tire to a preferable air pressure according to information related to at least one of a state of a road surface on which the human-powered vehicle will travel, a traveling state of the human-powered vehicle, and a state of a component mounted on the human-powered vehicle. The air-pressure adjusting device is capable of contributing to weight reduction of the traveling human-powered vehicle. In a case where change in an air pressure of a tire is determined to be needed during traveling of a human-powered vehicle, the human-powered vehicle is capable of traveling in a state where the air-pressure adjusting device is attached to the human-powered vehicle.

An air-pressure adjusting device of a forty-second aspect according to the fortieth aspect or the forty-first aspect, the control device is configured to: calculate the adjustment value of the air pressure of the tire by using an estimation model based on the at least one piece of information; and control the air pressure of the tire based on the adjustment value that was calculated.

The air-pressure adjusting device according to the forty-second aspect calculates an adjustment value of an air pressure of a tire by using an estimation model to be capable of calculate an air pressure that is appropriate for a tire. The air-pressure adjusting device is capable of preferably controlling an air pressure of a tire.

In accordance with a control device for a human-powered vehicle and an air-pressure adjusting device according to the present disclosure, it is possible to appropriately control an air pressure of a tire of the human-powered vehicle.

### BRIEF DESCRIPTION OF THE DRAWINGS

Referring now to the attached drawings which form a part of this original disclosure.

FIG. 1 is a side elevational view illustrating a human-powered vehicle provided with a control device and an air-pressure adjusting device according to a first embodiment.

FIG. 2 is a schematic diagram illustrating the air-pressure adjusting device of the human-powered vehicle according to the first embodiment.

FIG. 3 is a block diagram illustrating an electric configuration of the control device according to the first embodiment.

FIG. 4 is a flowchart illustrating an air-pressure control process according to the first embodiment.

FIG. 5 is a flowchart illustrating an air-pressure control process according to a second embodiment.

FIG. 6 is a flowchart illustrating an air-pressure control process according to a third embodiment.

FIG. 7 is a flowchart illustrating an air-pressure control process according to a fourth embodiment.

FIG. 8 is a block diagram illustrating an electric configuration of a control device according to a fifth embodiment.

FIG. 9 is a flowchart illustrating an air-pressure control process according to the fifth embodiment.

FIG. 10 is a flowchart illustrating an air-pressure control process according to a sixth embodiment.

FIG. 11 is a block diagram illustrating an electric configuration of a control device according to a seventh embodiment.

FIG. 12 is a flowchart illustrating an air-pressure control process according to the seventh embodiment.

FIG. 13 is a flowchart illustrating an air-pressure control process according to an eighth embodiment.

FIG. 14 is a flowchart illustrating an air-pressure control process according to a ninth embodiment.

FIG. 15 is a block diagram illustrating an air-pressure adjusting device according to a modification.

FIG. 16 is a block diagram illustrating a control device according to a modification.

### DETAILED DESCRIPTION OF EMBODIMENTS

Selected embodiments will now be explained with reference to the drawings. It will be apparent to those skilled in the human-powered vehicle field from this disclosure that the following descriptions of the embodiments are provided for illustration only and not for the purpose of limiting the invention as defined by the appended claims and their equivalents.

### First Embodiment

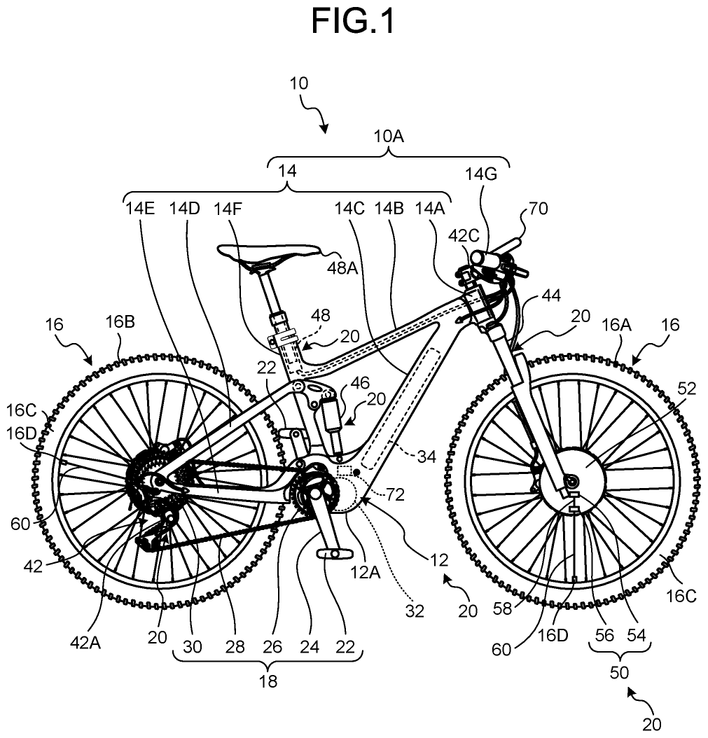

As illustrated in FIG. 1, a human-powered vehicle 10 is a mountain bicycle that includes an electric drive unit 12, for example. The human-powered vehicle 10 is not limited to a mountain bicycle, and is a vehicle that can be driven by at least human power. The human-powered vehicle 10 can be another-type bicycle such as a road bicycle, a cross bicycle, a city bicycle, a freight bicycle, a hand-cycle, and a recumbent bicycle. The human-powered vehicle 10 can be a vehicle that includes one or two or more wheels.

The human-powered vehicle 10 includes a vehicle body 10A. The vehicle body 10A includes a frame 14 and a handlebar 14G. The frame 14 includes a head tube 14A, a top tube 14B, a down tube 14C, a seat stay 14D, a chain stay 14E, and a seat tube 14F, for example. The head tube 14A, the top tube 14B, the down tube 14C, and the seat tube 14F constitute a front frame. The seat stay 14D and the chain stay 14E constitute a rear frame.

The human-powered vehicle 10 includes at least one wheel 16, a drive train 18, and a plurality of controlled targets 20. In the present embodiment, the at least one wheel 16 includes a front wheel 16A and a rear wheel 16B. Each of the front wheel 16A and the rear wheel 16B includes a tire 16C and a valve stem 16D. In the present embodiment, the electric drive unit 12 includes a part of the drive train 18.

The drive train 18 is configured to transmit a human-power driving force to a drive wheel. In the present embodiment, the rear wheel 16B is the drive wheel. The drive train 18 includes a chain 28. The drive train 18 further includes a pair of pedals 22, a crank 24, a front chain wheel 26, and a rear sprocket 30. A one-way clutch is arranged between the front chain wheel 26 and the crank 24, for example. In a case where the crank 24 rotates in a first rotational direction, the one-way clutch transmits rotational force from the crank 24 to the front chain wheel 26. In a case where the crank 24 rotates in a second rotational direction, the one-way clutch allows relative rotation between the crank 24 and the front chain wheel 26. The one-way clutch can be omitted. The human-power driving force applied to the pedals 22 is transmitted to the rear wheel 16B via the crank 24, the front chain wheel 26, the chain 28, and the rear sprocket 30. The rear sprocket 30 includes a plurality of sprockets, for example. The rear sprocket 30 includes two or more sprockets whose numbers of teeth are different from each other, for example. A one-way clutch is arranged between the rear sprocket 30 and the rear wheel 16B, for example. In a case where the rear sprocket 30 rotates in the first rotation direction, the one-way clutch transmits a rotational force from the rear sprocket 30 to the rear wheel 16B. In a case where the rear sprocket 30 rotates in the second rotation direction, the one-way clutch allows relative rotation between the rear sprocket 30 and the rear wheel 16B.

The drive train 18 can include pulleys and a belt, or can include bevel gears and a shaft instead of the front chain wheel 26, the rear sprockets 30, and the chain 28. The crank 24 includes a crank shaft, a first crank arm that is coupled to a first end part of the crank shaft in an axial direction, and a second crank arm that is coupled to a second end part of the crank shaft in the axial direction. The drive train 18 can have any configuration as long as the drive train 18 is configured to transmit the human-power driving force to a drive wheel. The front chain wheel 26 can include a plurality of chain wheels. For example, a rotational axis of the front chain wheel 26 is coaxially arranged with respect to a rotational axis of the crank 24. A rotational shaft of the rear sprockets 30 is coaxially arranged with respect to a rotational shaft of the rear wheel 16B.

The electric drive unit 12 is configured to provide a propelling force to the human-powered vehicle 10. The electric drive unit 12 assists the propelling force by the human-power driving force. The electric drive unit 12 operates in accordance with the human-power driving force applied to the pedals 22, for example. The electric drive unit 12 includes a first motor 32. The electric drive unit 12 includes a housing 12A. In the present embodiment, the electric drive unit 12 further includes a crank shaft and a drive-unit output shaft. The front chain wheel 26 is connected with the drive-unit output shaft. A rotational axis of the drive-unit output shaft is coaxially arranged with respect to a rotational axis of the crank 24. The drive-unit output shaft is connected to the crank shaft via a one-way clutch. The first motor 32 is provided in the housing 12A. The first motor 32 includes an electric motor.

The first motor 32 includes a brushless motor, for example. The first motor 32 is configured to be driven in a state where a drive wheel is rotated by human-power driving force. The first motor 32 is configured to assist in rotation of the drive wheel by the human-power driving force. Preferably, the electric drive unit 12 further includes a reducer. A rotational shaft of the first motor 32 is connected to the drive-unit output shaft via the reducer. The first motor 32 operates by using electric power supplied from a battery 34. The battery 34 is housed in the down tube 14C, for example. The electric drive unit 12 can be included in the wheel 16. The electric drive unit 12 can have any configuration as long as the electric drive unit 12 is capable of driving the wheel 16 directly or indirectly.

The controlled targets 20 include a transmission device 42. The controlled targets 20 include at least one of a front suspension 44 and a rear suspension 46. The controlled targets 20 include a seat post 48. The controlled targets 20 include the electric drive unit 12. The controlled targets 20 include an air-pressure adjusting device 50. In other words, the controlled targets 20 include at least one of the transmission device 42, the front suspension 44, the rear suspension 46, the seat post 48, the electric drive unit 12, and the air-pressure adjusting device 50.

The transmission device 42 is arranged on a transmission path of the human-power driving force. The transmission path of the human-power driving force is a route from the pedals 22 to a drive wheel. The transmission device 42 includes an external-mounted transmission. The transmission device 42 includes a derailleur 42A, for example. The derailleur 42A includes a rear derailleur. The derailleur 42A can include a front derailleur. The derailleur 42A moves the chain 28 from one of a plurality of sprockets to another of the plurality of sprockets. The transmission device 42 executes speed changing by movement of the chain between these sprockets.

A transmission ratio of the transmission device 42 is changed, thereby leading to change in a transmission of the transmission device 42. In a state where driving force is being transmitted from an input part of the transmission device 42 to an output part of the transmission device 42, a transmission ratio of the transmission device 42 is a ratio of a rotational speed of the output part of the transmission device 42 to a rotational speed of the input part of the transmission device 42. In a case where a rotational speed of the input part of the transmission device 42 is defined as Vi, a rotational speed of the output part of the transmission device 42 is defined as Vo, and a transmission ratio is defined as R, R is indicated by formula 1. In the present embodiment, Vi corresponds to a rotational speed of the crank 24, and Vo corresponds to a rotational speed of the drive wheel.

R=Vo/Vi (Formula 1)

The transmission device 42 can include an internal-mounted transmission instead of the external-mounted transmission. The transmission device 42 can include an internal-mounted transmission in addition to the external-mounted transmission. The internal-mounted transmission is arranged in a hub of the drive wheel, for example. The internal-mounted transmission can be a geared transmission or a gearless transmission.

The human-powered vehicle 10 has a manual transmission mode and an automatic transmission mode as a transmission mode of the transmission device 42. The transmission mode is a speed changing method in the transmission device 42. In a case where a transmission mode is a manual transmission mode, the transmission device 42 executes speed changing in accordance with a speed changing operation of a rider. In a case where a transmission mode is an automatic transmission mode, the transmission device 42 automatically executes speed changing in accordance with a traveling state of the human-powered vehicle 10. Change between a manual transmission mode and an automatic transmission mode is performed by a rider. For example, if a transmission operating device 42C is operated, a transmission mode is changed.

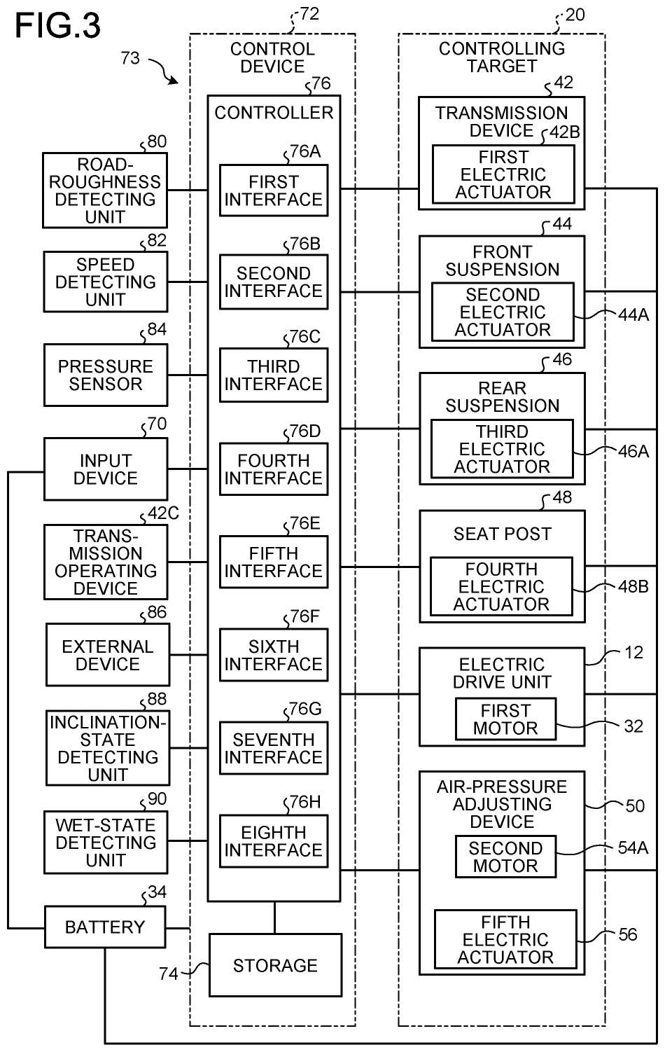

The transmission device 42 includes a first electric actuator 42B (see FIG. 3). The first electric actuator 42B includes an electric motor. The first electric actuator 42B can include an electric motor and a reducer connected with the electric motor. The first electric actuator 42B is provided to the derailleur 42A, for example. The first electric actuator 42B can be arranged separately from the derailleur 42A to be connected to the derailleur 42A with the use of a Bowden cable.

In a case where a transmission mode is a manual transmission mode, the first electric actuator 42B is driven in accordance with operation of the transmission operating device 42C, for example. The derailleur 42A is driven by driving force of the first electric actuator 42B. Electric power is supplied to the first electric actuator 42B from the battery 34. Electric power can be supplied to the transmission device 42 from a battery dedicated to the transmission device 42.

In a case where a transmission mode is an automatic transmission mode, the first electric actuator 42B is driven in accordance with a traveling state of the human-powered vehicle 10. The derailleur 42A is driven by a driving force of the first electric actuator 42B. The traveling state of the human-powered vehicle 10 includes a vehicle speed of the human-powered vehicle 10. The traveling state of the human-powered vehicle 10 can include at least one of a cadence of the crank 24 and a human-power driving force. The cadence is the rotation number per minute of the rotating crank 24, for example.

The front suspension 44 is provided to the frame 14. The front suspension 44 supports a hub of the front wheel 16A to be rotatable. The front suspension 44 includes a shock absorber that expands and contracts in a longitudinal direction thereof. The front suspension 44 attenuates an impact transmitted from a road surface. The front suspension 44 is configured to attenuate an impact transmitted from a road surface to the front wheel 16A by using the shock absorber.

The front suspension 44 includes a second electric actuator 44A (see FIG. 3). The second electric actuator 44A includes at least one electric motor or at least one solenoid. The second electric actuator 44A can include at least one electric motor and at least one solenoid. Electric power is supplied to the second electric actuator 44A from the battery 34. A configuration of the front suspension 44 is a general structure, and thus, detailed explanation thereof is omitted.

The second electric actuator 44A is directly or indirectly connected to a control valve provided in the front suspension 44. The second electric actuator 44A can be connected to a control valve of the front suspension 44 via a cable. The second electric actuator 44A adjusts a hardness of the front suspension 44. A hardness of the front suspension 44 is damping force of a shock absorber.

The rear suspension 46 is provided to the frame 14. The rear suspension 46 includes a first end part in an expanding-and-contracting direction thereof and a second end part in the expanding-and-contracting direction thereof. The first end part is connected with a front frame. The second end part is connected with a rear frame. The front frame and the rear frame are configured to be rotatable around respective predetermined rotational axes. The rear frame forms a swing arm. The rear suspension 46 includes a shock absorber that expands and contracts in a longitudinal direction thereof. The rear suspension 46 attenuates an impact from a road surface. The rear suspension 46 is configured to attenuate an impact transmitted from a road surface to the rear wheel 16B by using the shock absorber. The rear suspension 46 operates by electric power supplied from the battery 34.

The rear suspension 46 includes a third electric actuator 46A (see FIG. 3). The third electric actuator 46A includes at least one electric motor or at least one solenoid. The third electric actuator 46A can include at least one electric motor and at least one solenoid. Electric power is supplied to the third electric actuator 46A from the battery 34. A configuration of the rear suspension 46 is a general structure, and thus detailed explanation thereof is omitted.

The third electric actuator 46A is directly or indirectly connected to a control valve provided in the front suspension 44. The third electric actuator 46A can be connected to a control valve of the rear suspension 46 via a cable. The third electric actuator 46A adjusts a hardness of the rear suspension 46. A hardness of the rear suspension 46 is damping force of a shock absorber.

The seat post 48 is attached to the seat tube 14F. A saddle 48A is attached to the seat post 48. The seat post 48 is configured to change a length of a part protruding from the seat tube 14F so as to adjust a height from a road surface up to the saddle 48A. The seat post 48 operates by using electric power supplied from the battery 34. The seat post 48 includes a fourth electric actuator 48B (see FIG. 3). The fourth electric actuator 48B includes at least one electric motor or at least one solenoid. The fourth electric actuator 48B can include at least one electric motor and at least one solenoid. Electric power is supplied to the fourth electric actuator 48B from the battery 34. The seat post 48 includes a dropper seat post or an adjustable seat post. Configurations of the dropper seat post and the adjustable seat post are general ones, and thus detailed explanation thereof is omitted.

For example, the fourth electric actuator 48B is directly or indirectly connected to a control valve included in the seat post 48. The fourth electric actuator 48B can be connected to a control valve of the seat post 48 via a cable. The fourth electric actuator 48B opens/closes a control valve, for example. For example, in a state where a control valve is opened, the seat post 48 extends by hydraulic pressure, and a length thereof is kept by closing the control valve. The fourth electric actuator 48B can be configured not to control a control valve, and the seat post 48 can be configured to expand and contract by using a driving force of the fourth electric actuator 48B.

The air-pressure adjusting device 50 is configured to adjust an air pressure of the tire 16C of the wheel 16. The air-pressure adjusting device 50 adjusts an air pressure of the tire 16C during traveling, for example. The air-pressure adjusting device 50 is provided to each of the front wheel 16A and the rear wheel 16B. Note that as described below, the air-pressure adjusting device 50 can be provided separately from the human-powered vehicle 10 without being provided to the human-powered vehicle 10. The air-pressure adjusting device 50 can also be referred to as a tire air-pressure adjustor, which is a device that is capable of inflating and deflating a tire.

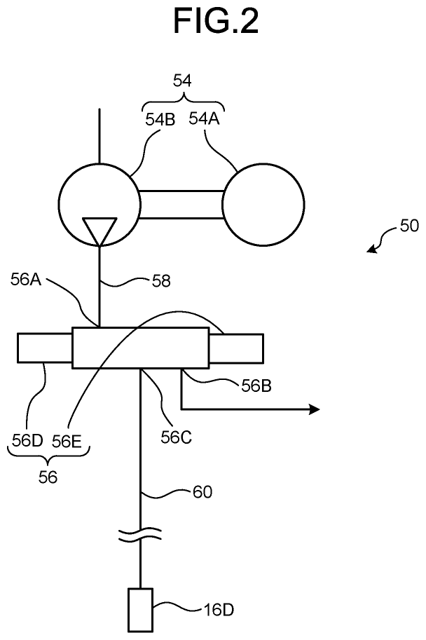

The air-pressure adjusting device 50 rotates integrally with the wheel 16. The air-pressure adjusting device 50 is attached to a rotational shaft of the wheel 16 via an attachment part 52. The attachment part 52 is coaxially arranged with a rotational shaft of the wheel 16. The attachment part 52 is a round-plate-shaped member, for example. The attachment part 52 rotates integrally with the wheel 16. The air-pressure adjusting device 50 includes a supplying unit 54 and a fifth electric actuator 56. The supplying unit 54 supplies compressed air to the tire 16C. As illustrated in FIG. 2, the supplying unit 54 includes a second motor 54A and a pump 54B. Electric power is supplied to the second motor 54A from the battery 34, and thus the second motor 54A is driven. The pump 54B is attached to a rotational shaft of the second motor 54A. The pump 54B rotates in accordance with rotation of a rotational shaft of the second motor 54A so as to take air from the outside. The pump 54B compresses the taken air, and discharges the compressed air. The pump 54B discharges the compressed air to an intake pipe 58. The supplying unit 54 can also be referred to as an air compressor.

The fifth electric actuator 56 is a solenoid valve, for example. Hereinafter, the fifth electric actuator 56 is explained as a solenoid valve 56 in some cases. The solenoid valve 56 changes a connection state between an intake port 56A or an exhaust port 56B and an output port 56C. In other words, the solenoid valve 56 changes between a first connection state and a second connection state. The first connection state is a state in which the intake port 56A and the output port 56C are connected to each other. The second connection state is a state in which the exhaust port 56B and the output port 56C are connected to each other. The intake port 56A is connected to the intake pipe 58. In other words, air compressed by the pump 54B is supplied to the intake port 56A via the intake pipe 58. The exhaust port 56B is formed so as to couple an inner part of the solenoid valve 56 to the outside thereof. The output port 56C is connected to an output pipe 60. The output pipe 60 connects the output port 56C of the solenoid valve 56 and the valve stem 16D to each other. The output pipe 60 is detachable from the valve stem 16D.

The solenoid valve 56 includes a first solenoid 56D and a second solenoid 56E. The solenoid valve 56 changes a connection state in which the intake port 56A are connected to the output port 56C or a connection state in which the exhaust port 56B are connected to the output port 56C in accordance with an energized state of the first solenoid 56D and the second solenoid 56E. In other words, the solenoid valve 56 changes between a first connection state and a second connection state in accordance with energized states of the first solenoid 56D and the second solenoid 56E. In a case where each of the solenoids 56D and 56E is not an energized state, connection states of the intake port 56A to the output port 56C and the exhaust port 56B to the output port 56C are a non-connection state. In the non-connection state, the output port 56C is not coupled to the intake port 56A or the exhaust port 56B.

In a case where the first solenoid 56D is in an energized state and further the second solenoid 56E is not an energized state, the solenoid valve 56 is in a first connection state. In the first connection state, the output port 56C is coupled to the intake port 56A, and is not coupled to the exhaust port 56B. Thus, air compressed by the pump 54B is injected into the tire 16C via the intake pipe 58, the solenoid valve 56, the output pipe 60, and the valve stem 16D. Thus, an air pressure of the tire 16C is increased.

In a case where the first solenoid 56D is not in an energized state and further the second solenoid 56E is in an energized state, the solenoid valve 56 is in a second connection state. In the second connection state, the output port 56C is coupled to the exhaust port 56B, and is not coupled to the intake port 56A. Thus, air in the tire 16C is ejected toward the outside via the valve stem 16D, the output pipe 60, and the solenoid valve 56. Thus, an air pressure of the tire 16C is reduced.

The supplying unit 54 of the air-pressure adjusting device 50 can be constituted of a gas tank that reserves air or nitrogen gas. The fifth electric actuator 56 of the air-pressure adjusting device 50 can include a solenoid valve for intake and a solenoid valve for exhaust. The fifth electric actuator 56 can be a motor. The pump 54B can take air from the outside caused by rotation of the tire 16C. In other words, the pump 54B can compress air by using rotation of the wheel 16, and further can discharge the compressed air into the intake pipe 58. For example, as disclosed in U.S. Patent Application Publication No. 2009/0151835, there has been known an in-hub tire pump whose body of a pump is completely housed in a hub and including a piston that moves an axial direction with respect to an axle. An actuator is fixed to an axle such that rotation of the axle is rotation of the actuator. The actuator corresponds to a cam follower. A distal surface of the piston is in mechanically contact with the actuator so as to form a cam. If the actuator rotates integrally with the axle, rotational movement of the axle is converted into reciprocating movement in an axial direction of the piston by the cam formed on a distal surface of the piston and the actuator. Thus, the piston moves in the axial direction and air in an air room is compressed, and thus air in the air room is pushed out from a check valve. If the axle continues to rotate, reciprocating movement of the piston in the axial direction thereof is repeated such that air is taken into a tire.

The human-powered vehicle 10 further includes an input device 70 and a human-powered vehicle control device 72. For example, the input device 70 is attached to the handlebar 14G of the human-powered vehicle 10. The input device 70 can be arranged in an arbitrary position of the human-powered vehicle 10, such as the top tube 14B, as long as it can be operated by a rider. The plurality of input devices 70 can be provided. The input device 70 receives various settings by a rider for at least a part of the controlled targets 20. The input device 70 is connected to the control device 72 to be able to communicate with each other by using an electric cable or a wireless communication device. The input device 70 includes a reception device of a satellite positioning system. The reception device of the satellite positioning system can be separately provided from the input device 70. The input device 70 is a cyclocomputer, for example. The input device 70 can include a smartphone. Electric power is supplied to the input device 70 from the battery 34.

As illustrated in FIG. 3, the human-powered vehicle control device 72 is operatively coupled to the controlled targets 20 for controlling the controlled targets 20. Hereinafter, the human-powered vehicle control device 72 will be simply referred to as the control device 72. A human-powered vehicle control system 73 includes the controlled targets 20 and the control device 72. The human-powered vehicle control system 73 will hereinafter be simply referred to as the control system 73. Basically, the human-powered vehicle control device 72 includes a storage 74 and an electronic controller 76. The storage 74 is any computer storage device or any non-transitory computer-readable medium with the sole exception of a transitory, propagating signal. For example, the storage 74 includes a non-volatile memory and a volatile memory. The non-volatile memory includes at least one of a Read Only Memory (ROM), a flash memory, and a hard disk, for example. The volatile memory includes a Random Access Memory (RAM), for example. The storage 74 stores therein software for controlling the controlled targets 20. The plurality of control devices 72 can be provided. For example, a control device whose controlled target is the air-pressure adjusting device 50 and a control device whose controlled target is the transmission device 42 and the like can be individually provided as respective control devices.

The electronic controller 76 is a computer, and will be hereinafter referred to as the controller 76. The controller 76 includes at least one calculation device (processor) such as a Central Processing Unit (CPU) and a Micro Processing Unit (MPU). The electronic controller 76 is formed of one or more semiconductor chips that are mounted on a circuit board. Thus, the terms “electronic controller” and “controller” as used herein refers to hardware that executes a software program, and does not include a human being. The controller 76 can include a plurality of calculation devices (processors). When the controller 76 includes a plurality of calculation devices (processors), the calculation devices can be separately arranged in respective separated positions. The controller 76 is configured such that the calculation device executes a control program stored in the ROM by using the RAM as a work region, for example, so as to control the controlled targets 20.

The controller 76 is connected to each of a road-roughness detecting unit 80, a speed detecting unit 82 (a speed sensor), a pressure sensor 84, the input device 70, and the transmission operating device 42C via at least one of an electric cable and a wireless communication device (a wireless communicator). The controller 76 is connected to an external device 86, an inclination-state detecting unit 88 (an inclination sensor), and a wet-state detecting unit 90 (a road surface sensor) via at least one of an electric cable and a wireless communication device. The terms “sensor” and “detector” as used herein refer to a hardware device or instrument designed to detect the presence or absence of a particular event, object, substance, or a change in its environment, and to emit a signal in response. The terms “sensor” and “detector” as used herein do not include a human being. The controller 76 is connected to the battery 34 via an electric cable.

Preferably, the controller 76 includes a first interface 76A. The first interface 76A is configured to receive information that is detected by the road-roughness detecting unit 80. Preferably, the controller 76 includes a second interface 76B. The second interface 76B is configured to receive information that is detected by the speed detecting unit 82. Preferably, the controller 76 includes a third interface 76C. The third interface 76C is configured to receive information that is detected by the pressure sensor 84.

Preferably, the controller 76 includes a fourth interface 76D. The fourth interface 76D is configured to receive information that is received by the input device 70. Preferably, the controller 76 includes a fifth interface 76E. The fifth interface 76E is configured to receive information that is transmitted from the transmission operating device 42C. Preferably, the controller 76 includes a sixth interface 76F. The sixth interface 76F is configured to receive information that is transmitted from the external device 86. Preferably, the controller 76 includes a seventh interface 76G. The seventh interface 76G is configured to receive information that is detected by the inclination-state detecting unit 88. Preferably, the controller 76 includes an eighth interface 76H. The eighth interface 76H is configured to receive information that is detected by the wet-state detecting unit 90.

Each of the first interface 76A to the eighth interface 76H includes at least one of a cable connecting port and a wireless communication device, for example. The wireless communication device includes a short-range distance wireless communication unit, for example. The short-range distance wireless communication unit is configured to execute wireless communication on the basis of a wireless communication standard such as Bluetooth® and ANT+, or an original wireless communication standard. In a case where an electric cable is connected with each of the first interface 76A to the eighth interface 76H, a corresponding cable connecting port can be omitted and the corresponding electric cable can be fixed thereto.

The road-roughness detecting unit 80 detects a road-surface-roughness on which the human-powered vehicle 10 is traveling. The road-roughness detecting unit 80 is configured to output information related to a road-surface-roughness on which the human-powered vehicle 10 is traveling to the controller 76. The road-roughness detecting unit 80 includes an acceleration sensor. The acceleration sensor detects a vibration of the human-powered vehicle 10 during traveling. The vibration is an acceleration of the human-powered vehicle 10 in a direction perpendicular to a road surface. The road-roughness detecting unit 80 can acquire information on road-surface-roughness from at least one of past traveling record and information that is available from the Internet. The road-roughness detecting unit 80 can detect the information on road surface on the basis of map information and positional information of the human-powered vehicle 10 which is detected by a reception device of a satellite positioning system. The map information is stored in the road-roughness detecting unit 80, for example. The map information can be acquired from the control device 72, the external device 86, or the like. In a case where the control device 72 includes map information, the map information is stored in the storage 74, for example.

The speed detecting unit 82 detects a traveling speed of the human-powered vehicle 10. The speed detecting unit 82 is configured to output information related to speed of the human-powered vehicle 10 to the controller 76. The speed detecting unit 82 includes a vehicle-speed sensor. The speed detecting unit 82 is provided to the chain stay 14E of the human-powered vehicle 10, for example. The speed detecting unit 82 includes a magnetic sensor. The speed detecting unit 82 is attached to a spoke, a disk brake rotor, or a hub of the wheel 16.

The speed detecting unit 82 is configured to output a signal if detecting a magnetic field, for example. The controller 76 is configured to operate a traveling speed of the human-powered vehicle 10. Operation of a traveling speed of the human-powered vehicle 10 is executed on the basis of information related to a time interval between signals or a width of a signal output from the speed detecting unit 82 in accordance with rotation of the wheel 16 and a circumference length of the wheel 16. As long as being configured to output information related to a speed of the human-powered vehicle 10, the speed detecting unit 82 can have any configuration. The speed detecting unit 82 can include, not limited to a magnetic sensor, another sensor such as an optical sensor, an acceleration sensor, and a reception device of a satellite positioning system.

The pressure sensor 84 detects an air pressure of the tire 16C. The pressure sensor 84 is configured to output information related to air pressure of the tire 16C to the controller 76. The pressure sensor 84 is provided to the output pipe 60, for example. The pressure sensor 84 can be provided to the valve stem 16D, for example.

The transmission operating device 42C includes an operation switch to be operated by a finger/hand of a rider or the like. Preferably, the transmission operating device 42C includes an operation switch for up-shift and an operation switch for down-shift. Preferably, the transmission operating device 42C is provided to the handlebar 14G.

The external device 86 is a device capable of changing setting of the human-powered vehicle 10 from the outside, for example. The external device 86 includes at least one of a smart device and a personal computer, for example. The smart device includes at least one of a wearable device such as a smartwatch, a smartphone, and a tablet computer, for example. The external device 86 can include at least one of a server device and a cloud system.

The inclination-state detecting unit 88 detects slope information related to an advancing direction of the human-powered vehicle 10. The inclination-state detecting unit 88 includes at least one of a slope sensor and an acceleration sensor. The slope sensor includes a gyro sensor, for example. Preferably, the gyro sensor includes a three-axis gyro sensor. The gyro sensor is configured to be capable of detecting a yaw angle of the human-powered vehicle 10, a roll angle of the human-powered vehicle 10, and a pitch angle of the human-powered vehicle 10. Preferably, three axes of the gyro sensor are provided to the human-powered vehicle 10 so as be along the front-back direction, the left-right direction, and the up-and-down direction of the human-powered vehicle 10. The three axes of the gyro sensor are adjusted in a state where the front wheel 16A and the rear wheel 16B are grounded on the horizontal plane while erecting thereon the human-powered vehicle 10. The gyro sensor can include a single-axis gyro sensor or a double-axis gyro sensor. The slope is a posture angle of the human-powered vehicle 10. The slope includes a posture angle of the human-powered vehicle 10 with respect to a road surface on which the human-powered vehicle 10 is traveling. In a case where the human-powered vehicle 10 is traveling or will travel on an upslope, the slope takes a positive value, for example. In a case where the human-powered vehicle 10 is traveling or will travel on a downslope, the slope takes a negative value, for example.

The inclination-state detecting unit 88 can detect slope information on the basis of map information and positional information of the human-powered vehicle 10 which is detected by a reception device of a satellite positioning system. The map information is stored in the inclination-state detecting unit 88, for example. The map information can be acquired from the control device 72, the external device 86, or the like. The inclination-state detecting unit 88 can include at least one of a cyclocomputer and a smartphone.

The wet-state detecting unit 90 detects a wet state of road surface. The wet state of road surface includes at least one of a state where a road surface is wet, a state where snow has piled up on a road surface, and a state where a road surface is frozen. The wet-state detecting unit 90 is a sensor that detects wetness of a road surface related to an advancing direction of the human-powered vehicle 10. The sensor that detects wetness of a road surface includes a camera and a detection device, for example. The wet-state detecting unit 90 captures a road surface by using the camera so as to detect presence/absence of specular reflection from the road surface. The wet-state detecting unit 90 detects presence/absence of specular reflection from a road surface on the basis of a luminance of image data acquired by the camera. The wet-state detecting unit 90 can include a polarized-light-filter rotating mechanism and a light receiving device. The wet-state detecting unit 90 can detect wetness of a road surface on the basis of a difference in an intensity between a vertical polarized light component and a horizontal polarized light component that are included in light reflected from the road surface, while rotating a polarized light filter. The wet-state detecting unit 90 can detect wetness information on the basis of weather information and positional information of the human-powered vehicle 10 that is detected by a reception device of a satellite positioning system. The wet-state detecting unit 90 can include a reception device of a satellite positioning system. The wet-state detecting unit 90 acquires weather information. The wet-state detecting unit 90 acquires weather information from the external device 86, for example. In a case where wireless communication is executed between the external device 86 and at least one of the input device 70 and the control device 72, the wet-state detecting unit 90 can acquire weather information from the input device 70 and the control device 72. The wet-state detecting unit 90 detects wetness of road surface on the basis of weather information in a position of the human-powered vehicle 10. For example, in a case where the weather in a position of the human-powered vehicle 10 during a predetermined time interval until the present time point is rain or snow, the wet-state detecting unit 90 detects wetness of a road surface. In other words, a wet state of road surface is decided by the weather during a predetermined time interval until the present time point. The predetermined time interval is a preset time interval. The predetermined time interval can be set on the basis of at least one of temperature, season, and time.

In a case where a transmission mode is a manual transmission mode, the controller 76 generates a signal for driving the first electric actuator 42B on the basis of a control signal received from the transmission operating device 42C. The controller 76 outputs the generated signal to the first electric actuator 42B. Thus, the first electric actuator 42B is driven so as to change a transmission ratio of the transmission device 42.

In a case where a transmission mode is an automatic transmission mode, the controller 76 generates a signal for driving the first electric actuator 42B on the basis of a traveling state of the human-powered vehicle 10. The controller 76 outputs the generated signal to the first electric actuator 42B. Thus, the first electric actuator 42B is driven so as to change a transmission ratio of the transmission device 42. The controller 76 controls the transmission device 42 so as to keep a cadence within a predetermined range, for example. In a case where a cadence is changed from a value within the predetermined range into a value lower than a lower-limit value of the predetermined range, the controller 76 controls the transmission device 42 so as to reduce a transmission ratio of the transmission device 42. In a case where a cadence is changed from a value within the predetermined range into a value larger than a predetermined upper-limit value, the controller 76 controls the transmission device 42 so as to increase a transmission ratio of the transmission device 42. The controller 76 can control the transmission device 42 in accordance with a traveling speed the human-powered vehicle 10. The controller 76 can control the transmission device 42 in accordance with human-power driving force working on the drive train 18 of the human-powered vehicle 10, for example.

In a case where a hardness of the front suspension 44 is changed by operation of the input device 70 by a rider, the controller 76 generates a signal for driving the second electric actuator 44A on the basis of a signal received from the input device 70. The controller 76 outputs the generated signal to the second electric actuator 44A. Thus, the second electric actuator 44A is driven so as to change a hardness of the front suspension 44. A hardness of the front suspension 44 can be changed by operation of the external device 86.

In a case where a hardness of the rear suspension 46 is changed by operation of the input device 70 by a rider, the controller 76 generates a signal for driving the third electric actuator 46A on the basis of a signal received from the input device 70. The controller 76 outputs the generated signal to the third electric actuator 46A. Thus, the third electric actuator 46A is driven so as to change a hardness of the rear suspension 46. A hardness of the rear suspension 46 can be changed by operation of the external device 86. A hardness of the front suspension 44 and a hardness of the rear suspension 46 can be individually changed. A hardness of the front suspension 44 and a hardness of the rear suspension 46 can be equally changed.

In a case where a height of the seat post 48 is changed by operation of the input device 70 by a rider, the controller 76 generates a signal for driving the fourth electric actuator 48B on the basis of a signal received from the input device 70. The controller 76 outputs the generated signal to the fourth electric actuator 48B. Thus, the fourth electric actuator 48B is driven so as to change a height of the seat post 48. A height of the seat post 48 can be changed by operation of the external device 86.

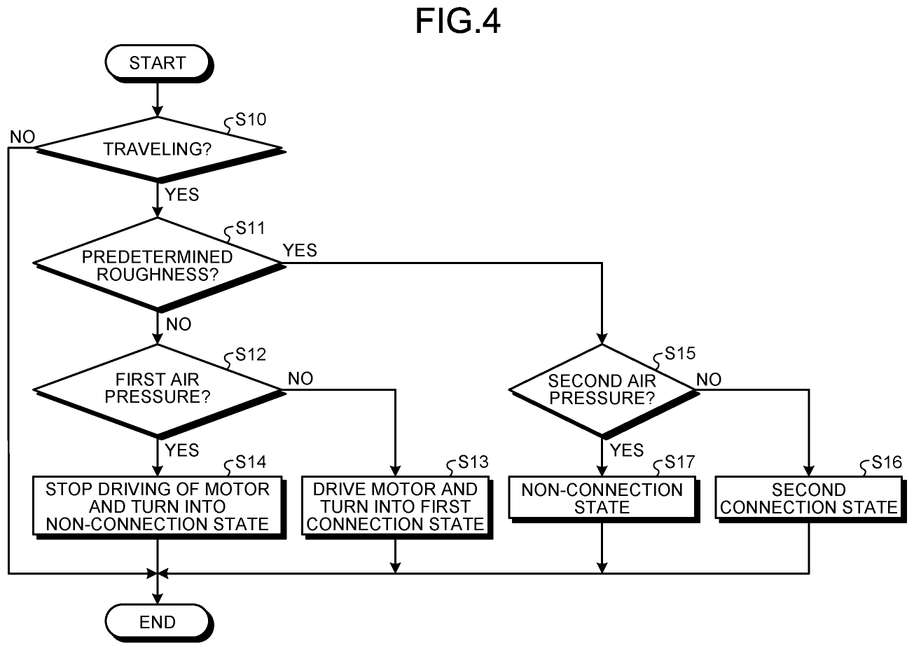

The controller 76 controls an air pressure of the tire 16C provided in the human-powered vehicle 10 on the basis of detection result of the road-roughness detecting unit 80. The controller 76 controls an air pressure of the tire 16C provided in the human-powered vehicle 10 on the basis of a road-surface-roughness on which the human-powered vehicle 10 is traveling or will travel. An air-pressure control process executed by the controller 76 according to a first embodiment will be explained with reference to FIG. 4.

In Step S10, the controller 76 determines whether or not the human-powered vehicle 10 is traveling. The controller 76 determines whether or not a traveling speed detected by the speed detecting unit 82 is larger than a first predetermined traveling speed. The first predetermined traveling speed is a preset speed. The first predetermined traveling speed is 0 km/h, for example.

In a case where the human-powered vehicle 10 is not traveling, the controller 76 ends the present processing. In a case where the human-powered vehicle 10 is traveling, the controller 76 shifts the processing to Step S11.

In Step S11, the controller 76 determines whether or not a road-surface-roughness is a predetermined roughness. The controller 76 determines whether or not a road-surface-roughness is a predetermined roughness on the basis of detection result of the road-roughness detecting unit 80. The road-surface-roughness is detected on the basis of vibration of the human-powered vehicle 10. The predetermined roughness is in a state where vibration is out of a predetermined vibration range. The predetermined vibration range is a range that is larger than a lower-limit vibration value and further is smaller than an upper-limit vibration value. The lower-limit vibration value is a preset value. The lower-limit vibration value is −0.3 G, for example. The lower-limit vibration value can be −0.5 G, for example. The lower-limit vibration value can be −1 G, for example. The lower-limit vibration value can be −5 G, for example. The lower-limit vibration value can be −10 G, for example. The upper-limit vibration value is a preset value. The upper-limit vibration value is +0.3 G, for example. The upper-limit vibration value can be +0.5 G, for example. The upper-limit vibration value can be +1 G, for example. The upper-limit vibration value can be +5 G, for example. The upper-limit vibration value can be +10 G, for example. In other words, the predetermined roughness is larger than a roughness within the predetermined vibration range. The lower-limit vibration value and the upper-limit vibration value can be set by a rider. The lower-limit vibration value and the upper-limit vibration value are set by operation of the input device 70, for example. The controller 76 determines whether or not vibration of the human-powered vehicle 10 is out of a predetermined vibration range. In a case where vibration of the human-powered vehicle 10 is out of the predetermined vibration range, the controller 76 determines that a road-surface-roughness is a predetermined roughness. In a case where vibration of the human-powered vehicle 10 is within the predetermined vibration range, the controller 76 determines that a road-surface-roughness is not a predetermined roughness. The lower-limit vibration value and the upper-limit vibration value can be set by operation of the external device 86.

In Step S11, in a case where determining that a road-surface-roughness is not a predetermined roughness, the controller 76 shifts the processing to Step S12. In other words, in a case where a road-surface-roughness is comparatively small, the road-surface-roughness is determined not to have a predetermined roughness. The controller 76 controls the air-pressure adjusting device 50 such that the tire 16C has a high air pressure. In Step S12, the controller 76 determines whether or not an air pressure of the tire 16C is a first air pressure value. Herein, the first air pressure value is a high air pressure value. The first air pressure value is a preset value. The first air pressure value is an air pressure value that is equal to or more than 29 psi, for example. The first air pressure value can be set by a rider. The first air pressure value is set by operation of the input device 70, for example. The first air pressure value can be set by operation of the external device 86. The first air pressure value can be a first air-pressure range. The first air-pressure range is a range that is equal to or more than a first lower limit air pressure value and further equal to or less than a first upper limit air pressure value. The first lower limit air pressure value and the first upper limit air pressure value are preset values. The first air-pressure range is equal to or more than 29 psi and further equal to or less than 36 psi, for example. The first air-pressure range is equal to or more than 29 psi and further equal to or less than 70 psi, for example. The first air-pressure range is equal to or more than 21 psi and further equal to or less than 37 psi, for example. The first air-pressure range can be set by a rider or the like. The first air-pressure range is set by operation of the input device 70, for example. The first air-pressure range can be set by operation of the external device 86. The first air pressure value can be set in accordance with a type of the human-powered vehicle 10 and a state of a road surface.

In Step S12, in a case where determining that an air pressure value of the tire 16C is not the first air pressure value, the controller 76 shifts the processing to Step S13.

In other words, a road-surface-roughness is in a state of being comparatively small, the tire 16C has a low air pressure. In Step S13, the controller 76 drives the second motor 54A of the air-pressure adjusting device 50, and further changes the solenoid valve 56 into a first connection state. Thus, air is injected into the tire 16C from the air-pressure adjusting device 50 so as to increase an air pressure of the tire 16C. In a case where a road-surface-roughness changes from a state of a predetermined roughness into a state of a non-predetermined roughness, the controller 76 causes the air-pressure adjusting device 50 to inject air into the tire 16C so as to increase an air pressure of the tire 16C. In a case where a road-surface-roughness reduces, the controller 76 increases an air pressure of the tire 16C.

In Step S12, in a case where determining that an air pressure value of the tire 16C is the first air pressure value, the controller 76 shifts the processing to Step S14. In other words, in a case where a road-surface-roughness is comparatively small, the tire 16C has a high air pressure. In Step S14, the controller 76 stops driving of the second motor 54A of the air-pressure adjusting device 50, and further turns the solenoid valve 56 into a non-connection state. In a case where driving of the second motor 54A of the air-pressure adjusting device 50 stops and the solenoid valve 56 is in a non-connection state, Step S13 is skipped.

In Step S11, in a case where determining that a road-surface-roughness is a predetermined roughness, the controller 76 shifts the processing to Step S15. In other words, in a case where a road-surface-roughness is comparatively large, a road-surface-roughness is determined to be a predetermined roughness. The controller 76 further controls the air-pressure adjusting device 50 such that the tire 16C has a low air pressure. In Step S15, the controller 76 determines whether or not an air pressure value of the tire 16C is a second air pressure value. Herein, the second air pressure value is a low air pressure value. The second air pressure value is a preset value. The second air pressure value is an air pressure value that is lower than 29 psi, for example. The second air pressure value is set by operation of the input device 70, for example. The second air pressure value can be set by operation of the external device 86. The second air pressure value can be a second air-pressure range. The second air-pressure range is a range that is equal to or more than a second lower-limit air pressure value and further is equal to or less than a second upper-limit air pressure value. The second lower-limit air pressure value and the second upper-limit air pressure value are preset values. The second air-pressure range is equal to or more than 16 psi and further equal to or less than 21 psi, for example. The second air-pressure range is equal to or more than 10 psi and further equal to or less than 29 psi, for example. The second air-pressure range can be set by a rider or the like. The second air-pressure range is set by operation of the input device 70, for example. The second air-pressure range can be set by operation of the external device 86. The second air pressure value can be set in accordance with a type of the human-powered vehicle 10 and a state of a road surface.

In Step S15, in a case where determining that an air pressure value of the tire 16C is not the second air pressure value, the controller 76 shifts the processing to Step S16. In other words, a road-surface-roughness is in a state of being comparatively large, the tire 16C has a high air pressure. In Step S16, the controller 76 changes the solenoid valve 56 of the air-pressure adjusting device 50 into a second connection state. Thus, air is discharged from the tire 16C by the air-pressure adjusting device 50 so as to reduce an air pressure of the tire 16C. In a case where a road-surface-roughness changes from a state of a non-predetermined roughness into a state of a predetermined roughness, the controller 76 causes the air-pressure adjusting device 50 to discharge air from the tire 16C so as to reduce an air pressure of the tire 16C. In a case where a road-surface-roughness increases, the controller 76 reduces an air pressure of the tire 16C.

In Step S15, in a case where determining that an air pressure value of the tire 16C is the second air pressure value, the controller 76 shifts the processing to Step S17. In other words, in a state where a road-surface-roughness is in a state of being comparatively large, the tire 16C has a low air pressure. In Step S17, the controller 76 turns the solenoid valve 56 of the air-pressure adjusting device 50 into a non-connection state. In a case where the solenoid valve 56 is a non-connection state, Step S16 is skipped.

The controller 76 can control an air pressure of the tire 16C on the basis of a value obtained by executing an interval average or a value obtained by moving average on vibration of the human-powered vehicle 10. A measurement interval of the vibration is equal to or more than 0.2 seconds, for example. A desired measurement interval of the vibration is equal to or more than 0.5 seconds. A measurement interval of the vibration can be equal to or less than 2 seconds, for example. A measurement interval of the vibration can be equal to or less than 5 seconds, for example. A measurement interval of the vibration is equal to or less than 10 seconds, for example.

### Second Embodiment

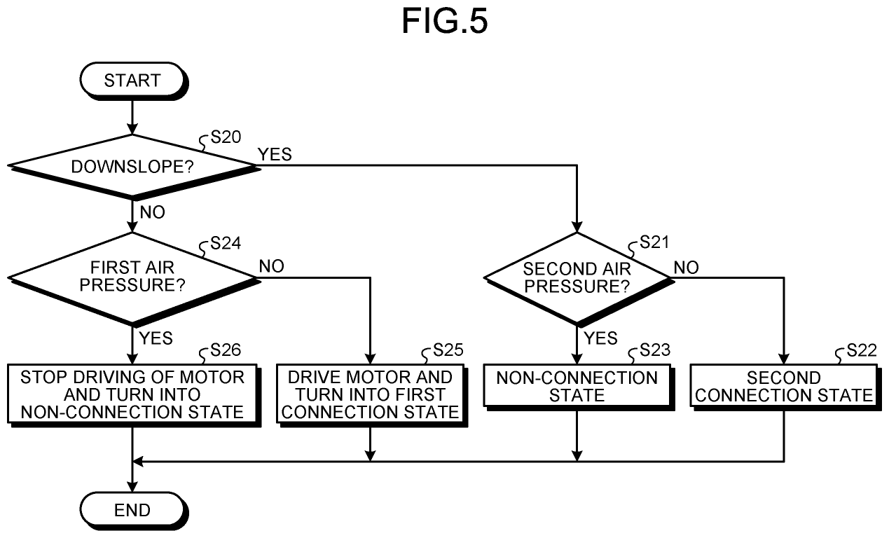

A part according to a second embodiment different from that according to the first embodiment will be explained. The controller 76 controls an air pressure of the tire 16C provided to the human-powered vehicle 10 on the basis of detection result of the inclination-state detecting unit 88. The controller 76 controls an air pressure of the tire 16C provided to the human-powered vehicle 10 on the basis of a slope state related to an advancing direction of the human-powered vehicle 10. An air-pressure control process according to the second embodiment will be explained with reference to FIG. 5.

In Step S20, the controller 76 determines whether or not a slope state in an advancing direction of the human-powered vehicle 10 is a downslope. The controller 76 determines whether or not a slope of a road surface on which the human-powered vehicle 10 is traveling or will travel is equal to or less than a predetermined slope. The predetermined slope is preset. The predetermined slope can be set by a rider or the like. The predetermined slope is set by operation of the input device 70, for example. The predetermined slope can be set by operation of the external device 86. In a case where a slope detected by the inclination-state detecting unit 88 is equal to or less than a predetermined slope, the controller 76 determines that a slope state is a downslope. In a case where a slope detected by the inclination-state detecting unit 88 is larger than a predetermined slope, the controller 76 determines that a slope state is not a downslope. In a case where a slope is larger than the predetermined slope, the controller 76 determines that a slope state is an upslope or a flat.

In Step S20, in a case where determining that a slope state is a downslope, the controller 76 shifts the processing to Step S21. In Step S21, the controller 76 determines whether or not an air pressure value of the tire 16C is the second air pressure value. As described above, the second air pressure value is a low air pressure value.

In Step S21, in a case where determining that an air pressure value of the tire 16C is not the second air pressure value, the controller 76 shifts the processing to Step S22. In other words, a slope state is in a state of a downslope, and the tire 16C has a high air pressure. The process of Step S22 is equal to the process of Step S16 according to the first embodiment. In other words, air is discharged by the air-pressure adjusting device 50 from the tire 16C so as to reduce an air pressure of the tire 16C. Thus, detailed explanation of the process of Step S22 is omitted. In a case where a slope state is changed from a state of a non-downslope into a state of a downslope, the controller 76 reduces an air pressure of the tire 16C. In a case where a downslope of the road surface is detected as a slope state, the controller 76 reduces an air pressure of the tire 16C. In a case where a downslope of the road surface is detected, the controller 76 reduces an air pressure of the tire 16C lower than an air pressure of the tire 16C at an upslope of the road surface or a flat slope of the road surface.

In Step S21, in a case where determining that an air pressure value of the tire 16C is the second air pressure value, the controller 76 shifts the processing to Step S23. In other words, a slope state is a state of a downslope, the tire 16C has a low air pressure. The process of Step S23 is equal to the process of Step S17 according to the first embodiment. In other words, the controller 76 turns the solenoid valve 56 of the air-pressure adjusting device 50 into a non-connection state. Thus, detailed explanation of the process of Step S23 is omitted.

In Step S20, in a case where determining that a slope state is not a downslope, the controller 76 shifts the processing to Step S24. In Step S24, the controller 76 determines whether or not an air pressure value of the tire 16C is the first air pressure value. As described above, the first air pressure value is a high air pressure value.

In Step S24, in a case where determining that an air pressure value of the tire 16C is not the first air pressure value, the controller 76 shifts the processing to Step S25. In other words, a slope state is in a state of an up slope or a flat, the tire 16C has a low air pressure. The process of Step S25 is equal to the process of Step S13 according to the first embodiment. In other words, the controller 76 causes the air-pressure adjusting device 50 to inject air into the tire 16C so as to increase an air pressure of the tire 16C. Thus, detailed explanation of the process of Step S25 is omitted. In a case where a slope state changes from a state of a downslope into a state of a non-downslope, the controller 76 increases an air pressure of the tire 16C. In a case an upslope of the road surface is detected as a slope state, the controller 76 increases an air pressure of the tire 16C. In a case where a flat slope of the road surface is detected as a slope state, the controller 76 increases an air pressure of the tire 16C. In a case where an upslope of the road surface or a flat slope of the road surface is detected, the controller 76 increases an air pressure of the tire 16C to be higher than an air pressure of the tire 16C at a downslope.

In Step S24, in a case where determining that an air pressure value of the tire 16C is the first air pressure value, the controller 76 shifts the processing to Step S26. In other words, a slope state is in a state of an upslope or a flat, the tire 16C has a high air pressure. The process of Step S26 is equal to the process of Step S14 according to the first embodiment. In other words, the controller 76 stops driving of the second motor 54A of the air-pressure adjusting device 50 so as to turn the solenoid valve 56 into a non-connection state. Thus, detailed explanation of the process of Step S25 is omitted.

In a case where detecting an upslope of the road surface, the controller 76 can increase an air pressure of the tire 16C higher than an air pressure of the tire 16C at a road surface of a flat. For example, in accordance with a slope state, the controller 76 sets an air pressure of the tire 16C to the first air-pressure range, the second air-pressure range, and a third air-pressure range. The third air-pressure range is a range that is lower than the first air-pressure range and further higher than the second air-pressure range. For example, the third air-pressure range is a range that is higher than 21 psi and further lower than 29 psi. In a case where a slope state is an upslope of the road surface, the controller 76 sets an air pressure of the tire 16C to the first air-pressure range. In a case where a slope state is a flat slope of the road surface, the controller 76 sets an air pressure of the tire 16C to the third air-pressure range.

### Third Embodiment

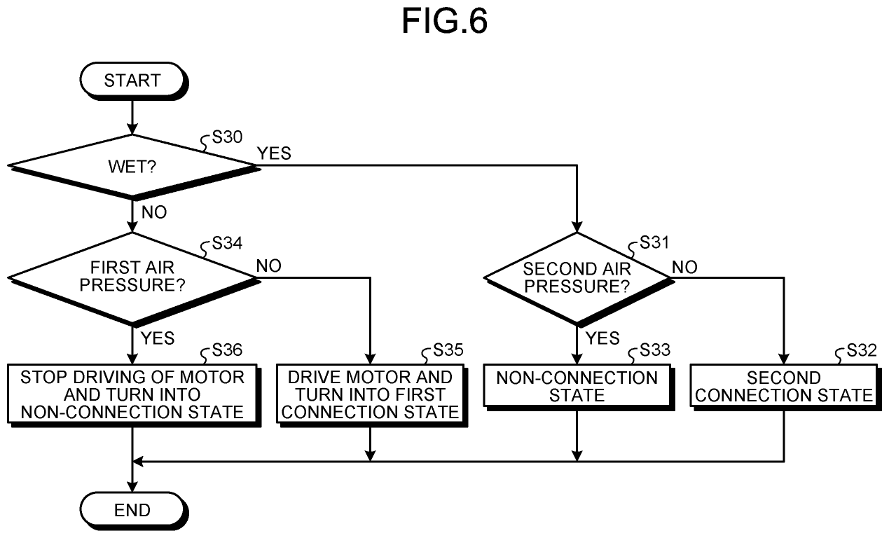

A part according to a third embodiment different from that according to the first embodiment will be explained. The controller 76 controls an air pressure of the tire 16C provided to the human-powered vehicle 10 on the basis of detection result of the wet-state detecting unit 90. The controller 76 controls an air pressure of a tire 10C provided to the human-powered vehicle 10 on the basis of a wet state of a road surface. An air-pressure control process according to the third embodiment will be explained with reference to FIG. 6.

In Step S30, the controller 76 determines whether or not a road surface on which the human-powered vehicle 10 is traveling is wet. In Step S30, in a case where determining that a road surface on which the human-powered vehicle 10 is traveling is wet, the controller 76 shifts the processing to Step S31. In Step S31, the controller 76 determines whether or not an air pressure value of the tire 16C is the second air pressure value. As described above, the second air pressure value is a low air pressure value.

In Step S31, in a case where determining that an air pressure value of the tire 16C is not the second air pressure value, the controller 76 shifts the processing to Step S32. In other words, a road surface is in a state of being wet, and the tire 16C has a high air pressure. The process of Step S32 is equal to the process of Step S16 according to the first embodiment. In other words, the controller 76 causes the air-pressure adjusting device 50 to discharge air from the tire 16C so as to reduce an air pressure of the tire 16C. Thus, detailed explanation of the process of Step S32 is omitted. In a case where a road surface is detected to be wet, the controller 76 reduces an air pressure of the tire 16C. In a case where a road surface is detected to be wet, the controller 76 reduces an air pressure of the tire 16C to be lower than an air pressure of the tire 16C in a case where the road surface is not wet.

In Step S31, in a case where determining that an air pressure value of the tire 16C is the second air pressure value, the controller 76 shifts the processing to Step S33. In other words, in a case where a road surface is wet, the tire 16C has a low air pressure. The process of Step S33 is equal to the process of Step S17 according to the first embodiment. In other words, the controller 76 turns the solenoid valve 56 of the air-pressure adjusting device 50 into a non-connection state. Thus, detailed explanation of the process of Step S33 is omitted.

In Step S30, in a case where determining that a road surface is not wet, the controller 76 shifts the processing to Step S34. In Step S34, the controller 76 determines whether or not an air pressure value of the tire 16C is the first air pressure value. As described above, the first air pressure value is a high air pressure value.

In Step S34, in a case where determining that an air pressure value of the tire 16C is not the first air pressure value, the controller 76 shifts the processing to Step S35. In other words, in a case of “No” in Step 34, a road surface is not wet and further the tire 16C has a low air pressure. The process of Step S35 is equal to the process of Step S13 according to the first embodiment. In other words, the controller 76 causes the air-pressure adjusting device 50 to inject air into the tire 16C so as to increase an air pressure of the tire 16C. Thus, detailed explanation of the process of Step S35 is omitted. In a case where detecting that a road surface is not wet, the controller 76 increases an air pressure of the tire 16C. In a case where detecting that a road surface is not wet, the controller 76 increases an air pressure of the tire 16C to be higher than an air pressure of the tire 16C in a case where the road surface is wet.

In Step S34, in a case where determining that an air pressure value of the tire 16C is the first air pressure value, the controller 76 shifts the processing to Step S36. In other words, a road surface is in a state not being wet, and the tire 16C has a high air pressure. The process of Step S36 is equal to the process of Step S14 according to the first embodiment. In other words, the controller 76 stops driving of the second motor 54A of the air-pressure adjusting device 50, and further turns the solenoid valve 56 into a non-connection state. Thus, detailed explanation of the process of Step S36 is omitted.

### Fourth Embodiment

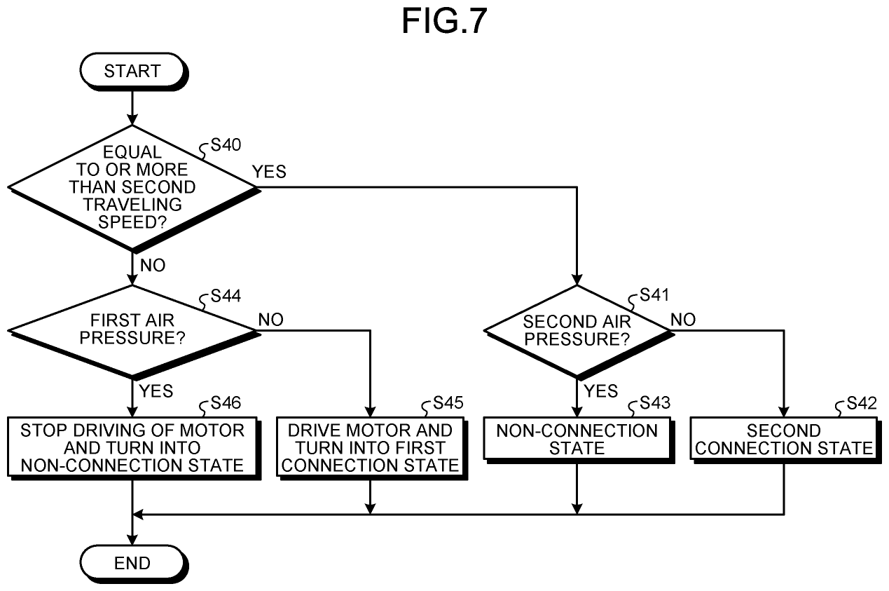

A part according to a fourth embodiment different from that according to the first embodiment will be explained. The controller 76 controls an air pressure of the tire 16C provided to the human-powered vehicle 10 on the basis of detection result of the speed detecting unit 82. The controller 76 controls an air pressure of the tire 16C provided to the human-powered vehicle 10 on the basis of a traveling speed of the human-powered vehicle 10. An air-pressure control process according to the fourth embodiment will be explained with reference to FIG. 7.

In Step S40, the controller 76 determines whether or not a traveling speed of the human-powered vehicle 10 is equal to or more than a second traveling speed. The second traveling speed is a preset speed. The second traveling speed is 20 km/h, for example. The second traveling speed can be set by a rider or the like. For example, the second traveling speed is set by operation of the input device 70. The second traveling speed can be set by operation of the external device 86. In a case where determining that a traveling speed is equal to or more than the second traveling speed, the controller 76 shifts the processing to Step S41. In Step S41, the controller 76 determines whether or not an air pressure value of the tire 16C is the second air pressure value. As described above, the second air pressure value is a low air pressure value.

In Step S41, in a case where determining that an air pressure value of the tire 16C is not the second air pressure value, the controller 76 shifts the processing to Step S42. In other words, a traveling speed is in a state of being large, and the tire 16C has a high air pressure. The process of Step S42 is equal to the process of Step S16 according to the first embodiment. In other words, the controller 76 causes the air-pressure adjusting device 50 to discharge air from the tire 16C so as to reduce an air pressure of the tire 16C. Thus, detailed explanation of the process of Step S42 is omitted. In a case where a traveling speed increases, the controller 76 reduces an air pressure of the tire 16C. In a case where a traveling speed is equal to or more than the second traveling speed from a state of being less than the second traveling speed, the controller 76 reduces an air pressure of the tire 16C to be lower than an air pressure of the tire 16C in a case where the traveling speed is lower than the second traveling speed.

In Step S41, in a case where determining that an air pressure value of the tire 16C is the second air pressure value, the controller 76 shifts the processing to Step S43. In other words, a traveling speed is in a state of being large, and the tire 16C has a low air pressure. The process of Step S43 is equal to the process of Step S17 according to the first embodiment. In other words, the controller 76 turns the solenoid valve 56 of the air-pressure adjusting device 50 into a non-connection state. Thus, detailed explanation of the process of Step S43 is omitted.

In Step S40, in a case where determining that a traveling speed is smaller than a second predetermined traveling speed, the controller 76 shifts the processing to Step S44. In other words, in a case where determining that a traveling speed is not equal to or more than the second traveling speed, the controller 76 shifts the processing to Step S44. In Step S44, the controller 76 determines whether or not an air pressure value of the tire 16C is the first air pressure value. As described above, the first air pressure value is a high air pressure value.

In Step S44, in a case where determining that an air pressure value of the tire 16C is not the first air pressure value, the controller 76 shifts the processing to Step S45. In other words, a traveling speed is in a state of being small, and the tire 16C has a low air pressure. The process of Step S45 is equal to the process of Step S13 according to the first embodiment. In other words, the controller 76 causes the air-pressure adjusting device 50 to inject air into the tire 16C so as to increase an air pressure of the tire 16C. Thus, detailed explanation of the process of Step S45 is omitted. In a case where a traveling speed reduces, the controller 76 increases an air pressure of the tire 16C. In a case where a traveling speed is smaller than the second traveling speed from a state of being equal to or more than the second traveling speed, the controller 76 increases an air pressure of the tire 16C to be higher than an air pressure of the tire 16C in a case where a traveling speed is equal to or more than the second traveling speed.

In Step S44, in a case where determining that an air pressure value of the tire 16C is the first air pressure value, the controller 76 shifts the processing to Step S46. In other words, a traveling speed is in a state of being small, and further the tire 16C has a high air pressure. The process of Step S46 is equal to the process of Step S14 according to the first embodiment. In other words, the controller 76 stops driving of the second motor 54A of the air-pressure adjusting device 50, and further turns the solenoid valve 56 into a non-connection state. Thus, detailed explanation of the process of Step S46 is omitted.

The controller 76 can divide a traveling speed into three or more ranges so as to control an air pressure of the tire 16C. For example, a traveling speed includes a first speed range, a second speed range, and a third speed range. For example, a speed of the first speed range is small, a speed of the third speed range is large, and a speed of the second speed range is between the first speed range and the third speed range. The first speed range is a range in which a traveling speed is less than a third traveling speed, for example. The third traveling speed is a preset speed. The third traveling speed is 15 km/h, for example. The second speed range is a range in which a traveling speed is equal to or more than the third traveling speed, and further equal to or less than the second traveling speed. As described above, the second traveling speed is 20 km/h, for example. The third speed range is a range in which a traveling speed is larger than the second traveling speed. The third traveling speed can be set by a rider or the like. The third traveling speed is set by operation of the input device 70, for example. The third traveling speed can be set by operation of the external device 86. In a case where a traveling speed is the first speed range, the controller 76 sets an air pressure of the tire 16C to the first air-pressure range (29 psi 23 first air-pressure range≤36 psi), for example. In a case where a traveling speed is the second speed range, the controller 76 sets an air pressure of the tire 16C to the third air-pressure range (21 psi<third air-pressure range<29 psi), for example. In a case where a traveling speed is the third speed range, the controller 76 sets an air pressure of the tire 16C to the second air-pressure range (16 psi<second air-pressure range≤21 psi), for example. Each of a speed range and an air-pressure range can be divided into four or more ranges. The controller 76 more reduces an air pressure of the tire 16C as a traveling speed is larger.

### Fifth Embodiment

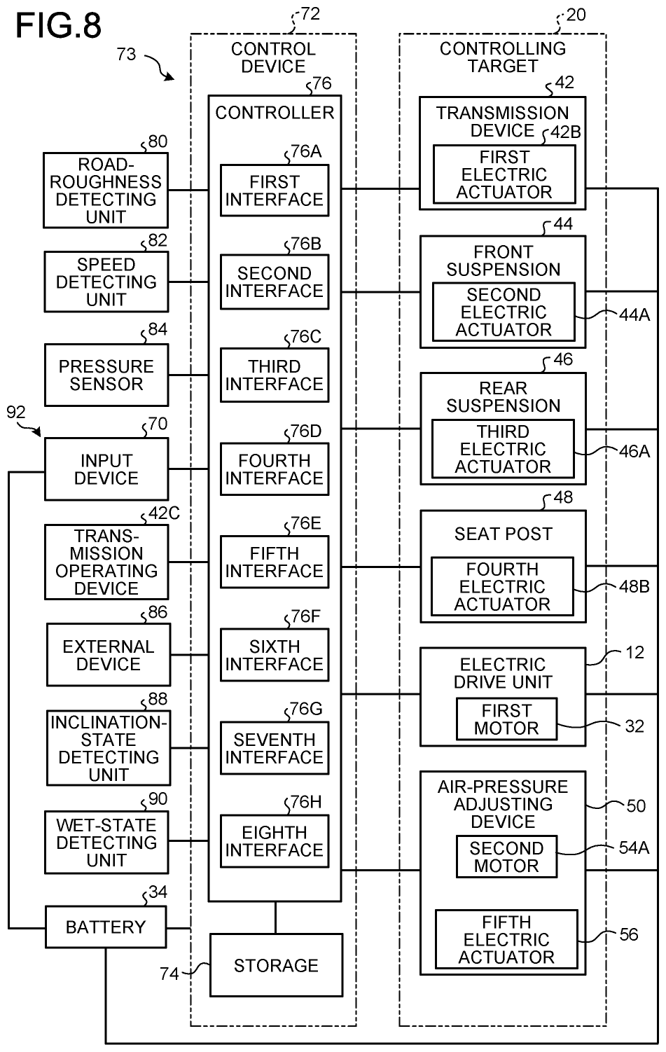

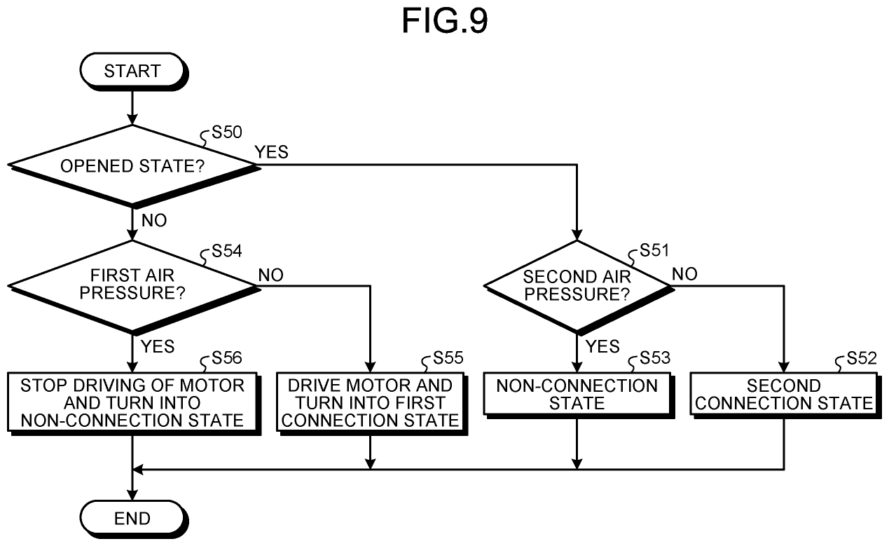

A part according to a fifth embodiment different from that according to the first embodiment will be explained. The controller 76 controls an air pressure of the tire 16C provided to the human-powered vehicle 10 on the basis of detection result of a component-state detecting unit 92. The component-state detecting unit 92 detects a state of a component provided to the human-powered vehicle 10. The controller 76 controls an air pressure of the tire 16C provided to the human-powered vehicle 10 on the basis of a state of a component provided to the human-powered vehicle 10. The component-state detecting unit 92 is the input device 70 as illustrated in FIG. 8, for example. The component-state detecting unit 92 can be a sensor that detects a state of a component. The component includes the suspensions 44 and 46 arranged on the frame 14 so as to reduce an impact from a road surface. States of the suspensions 44 and 46 are changed by operation of a rider which is input to the input device 70, for example. States of the suspensions 44 and 46 are detected by the input device 70 that is the component-state detecting unit 92, for example. States of the suspensions 44 and 46 can be detected by a sensor or the like, which is provided to the suspensions 44 and 46. An air-pressure control process according to the fifth embodiment will be explained with reference to FIG. 9.

In Step S50, the controller 76 determines whether or not the suspensions 44 and 46 are in an opened state. For example, the controller 76 determines whether or not settings of the suspensions 44 and 46 in the input device 70 are in an opened state. The opened state is a state where an impact applied from a road surface is attenuated by the suspensions 44 and 46. For example, the opened state is a state where a damping force in the shock absorber is equal to or more than a predetermined damping force. In a case where the suspensions 44 and 46 are not in an opened state, the controller 76 determines that states of the suspensions 44 and 46 are closed states. The closed state is a state where an impact applied from a road surface is not attenuated by the suspensions 44 and 46. The closed state can include a state whose damping force is smaller than that of the opened state.

In Step S50, in a case where determining that the suspensions 44 and 46 are in an opened state, the controller 76 shifts the processing to Step S51. In Step S51, the controller 76 determines whether or not an air pressure value of the tire 16C is the second air pressure value. As described above, the second air pressure value is a low air pressure value.

In Step S51, in a case where determining that an air pressure value of the tire 16C is not the second air pressure value, the controller 76 shifts the processing to Step S52. In other words, the suspensions 44 and 46 are in an opened state, and further the tire 16C has a high air pressure. The process of Step S52 is equal to the process of Step S16 according to the first embodiment. In other words, the controller 76 causes the air-pressure adjusting device 50 to discharge air from the tire 16C so as to reduce an air pressure of the tire 16C. Thus, detailed explanation of the process of Step S52 is omitted. In a case where the suspensions 44 and 46 are adjusted so as to increase function for reducing an impact, the controller 76 reduces an air pressure of the tire 16C. In a case where states of the suspensions 44 and 46 are changed from a closed state into an opened state, the controller 76 reduces an air pressure of the tire 16C to be lower than an air pressure of the tire 16C in a closed state.

In Step S51, in a case where determining that an air pressure value of the tire 16C is the second air pressure value, the controller 76 shifts the processing to Step S53. In other words, in a case where the suspensions 44 and 46 are in an opened state, the tire 16C has a low air pressure. The process of Step S53 is equal to the process of Step S17 according to the first embodiment. In other words, the controller 76 turns the solenoid valve 56 of the air-pressure adjusting device 50 into a non-connection state. Thus, detailed explanation of the process of Step S53 is omitted.

In Step S50, in a case where determining that the suspensions 44 and 46 are not in an opened state, the controller 76 shifts the processing to Step S54. In Step S54, the controller 76 determines whether or not an air pressure value of the tire 16C is the first air pressure value. As described above, the first air pressure value is a high air pressure value.

In Step S54, in a case where determining that an air pressure value of the tire 16C is not the first air pressure value, the controller 76 shifts the processing to Step S55. In other words, in a case where the suspensions 44 and 46 are in a closed state, the tire 16C has a low air pressure. The process of Step S55 is equal to the process of Step S13 according to the first embodiment. In other words, the controller 76 causes the air-pressure adjusting device 50 to inject air into the tire 16C so as to increase an air pressure of the tire 16C. Thus, detailed explanation of the process of Step S55 is omitted. In a case where the suspensions 44 and 46 are adjusted so as to reduce function for reducing an impact, the controller 76 increases an air pressure of the tire 16C. In a case where states of the suspensions 44 and 46 are changed from an opened state into a closed state, the controller 76 increases an air pressure of the tire 16C to be higher than an air pressure of the tire 16C in an opened state.

In Step S54, in a case where determining that an air pressure value of the tire 16C is the first air pressure value, the controller 76 shifts the processing to Step S56. In other words, the suspensions 44 and 46 are in a closed state, and further the tire 16C has a high air pressure. The process of Step S56 is equal to the process of Step S14 according to the first embodiment. In other words, the controller 76 stops driving of the second motor 54A of the air-pressure adjusting device 50, and further turns the solenoid valve 56 into a non-connection state. Thus, detailed explanation of the process of Step S56 is omitted.

The controller 76 can control an air pressure of the tire 16C in accordance with damping force of an impact in the suspensions 44 and 46. For example, the controller 76 can control an air pressure of the tire 16C in accordance with hardness of the suspensions 44 and 46. The controller 76 increases an air pressure of the tire 16C more as the suspensions 44 and 46 are harder. The controller 76 more reduces an air pressure of the tire 16C as the suspensions 44 and 46 are softer.

The controller 76 can determine whether the suspensions 44 and 46 are in an opened state or a closed state on the basis of an operation state of the second electric actuator 44A and an operation state of the third electric actuator 46A. An air pressure of the front wheel 16A and an air pressure of the rear wheel 16B can be individually adjusted. An air pressure of the front wheel 16A is adjusted in accordance with a state of the front suspension 44. An air pressure of the rear wheel 16B is adjusted in accordance with a state of the rear suspension 46.

Sixth Embodiment

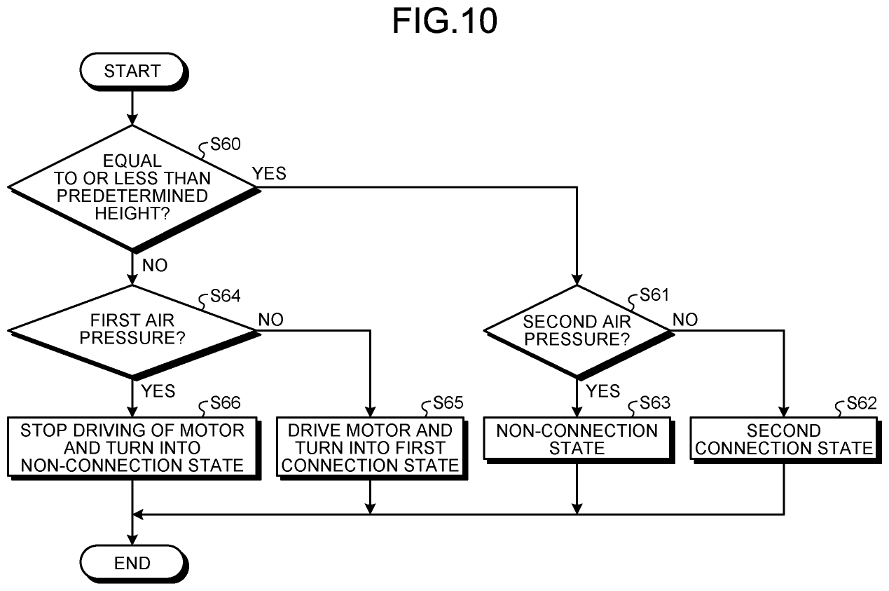

A part according to a sixth embodiment different from those according to the first embodiment and the fifth embodiment will be explained. The component is the seat post 48 that is capable of adjusting a height of the saddle 48A of the human-powered vehicle 10. As illustrated in FIG. 8, the component-state detecting unit 92 is the input device 70, for example. A state of the seat post 48 is changed by operation of a rider which is input into the input device 70, for example. A state of the seat post 48 is detected by the input device 70 that is the component-state detecting unit 92, for example. Note that a state of the seat post 48 can be detected by a sensor provided to the seat post 48 or the like. An air-pressure control process according to the sixth embodiment will be explained with reference to FIG. 10.

In Step S60, the controller 76 determines whether or not a height of the seat post 48 is equal to or less than a predetermined height. The controller 76 determines whether or not a height of the seat post 48 that is set in the input device 70 is equal to or less than a predetermined height, for example. The predetermined height is a preset height. The predetermined height can be set in accordance with a type of the human-powered vehicle 10. The predetermined height can be set by a rider or the like. The predetermined height is set by operation of the input device 70, for example. The predetermined height can be set by operation of the external device 86.

A change amount of a height of the seat post 48 is appropriately from 100 mm to 180 mm, for example. Adjustment in a position where the seat post 48 is high can be executed in a position that is higher than 50% of a stroke on an expanding side of the seat post 48, for example. Adjustment in a position where the seat post 48 is low can be executed in a position that is lower than 50% of a stroke on a contracting side of the seat post 48, for example.

In Step S60, in a case where determining that a height of the seat post 48 is equal to or less than a predetermined height, the controller 76 shifts the processing to Step S61. In Step S61, the controller 76 determines whether or not an air pressure value of the tire 16C is the second air pressure value. As described above, the second air pressure value is a low air pressure value.

In Step S61, in a case where determining that an air pressure value of the tire 16C is not the second air pressure value, the controller 76 shifts the processing to Step S62. In other words, a height of the seat post 48 is in a state of being low, and the tire 16C has a high air pressure. The process of Step S62 is equal to the process of Step S16 according to the first embodiment. In other words, the controller 76 causes the air-pressure adjusting device 50 to discharge air from the tire 16C so as to reduce an air pressure of the tire 16C. Thus, detailed explanation of Step S62 is omitted. In a case where a height of the seat post 48 is adjusted to be low, the controller 76 reduces an air pressure of the tire 16C. In a case where a height of the seat post 48 is changed from a state of being higher than a predetermined height into a state of being equal to or less than the predetermined height, the controller 76 reduces an air pressure of the tire 16C to be lower than an air pressure of the tire 16C in a case where a height of the seat post 48 is higher than the predetermined height.

In Step S61, in a case where determining that an air pressure value of the tire 16C is the second air pressure value, the controller 76 shifts the processing to Step S63. In other words, a height of the seat post 48 is in a state of being low, and further the tire 16C has a low air pressure. The process of Step S63 is equal to the process of Step S17 according to the first embodiment. In other words, the controller 76 turns the solenoid valve 56 of the air-pressure adjusting device 50 into a non-connection state. Thus, detailed explanation of the process of Step S63 is omitted.

In Step S60, in a case where determining that a height of the seat post 48 is higher than a predetermined height, the controller 76 shifts the processing to Step S64. In other words, in Step S60, in a case where determining that a height of the seat post 48 is not equal to or less than a predetermined height, the controller 76 shifts the processing to Step S64. In Step S64, the controller 76 determines whether or not an air pressure value of the tire 16C is the first air pressure value. As described above, the first air pressure value is a high air pressure value.

In Step S64, in a case where determining that an air pressure value of the tire 16C is not the first air pressure value, the controller 76 shifts the processing to Step S65. In other words, a height of the seat post 48 is in a state of being high, and further the tire 16C has a low air pressure. The process of Step S65 is equal to the process of Step S13 according to the first embodiment. In other words, the controller 76 causes the air-pressure adjusting device 50 to inject air into the tire 16C so as to increase an air pressure of the tire 16C. Thus, detailed explanation of the process of Step S65 is omitted. In a case where a height of the seat post 48 is adjusted to be high, the controller 76 increases an air pressure of the tire 16C. In a case where a height of the seat post 48 is changed from a state of being equal to or less than a predetermined height into a state of being higher than the predetermined height, the controller 76 changes an air pressure of the tire 16C to be higher than an air pressure of the tire 16C in a case where a height of the seat post 48 is equal to or less than the predetermined height.

In Step S64, in a case where determining that an air pressure value of the tire 16C is the first air pressure value, the controller 76 shifts the processing to Step S66. In other words, a height of the seat post 48 is in a state of being high, and further the tire 16C has a high air pressure. The process of Step S66 is equal to the process of Step S14 according to the first embodiment. In other words, the controller 76 stops driving of the second motor 54A of the air-pressure adjusting device 50, and further turns the solenoid valve 56 into a non-connection state. Thus, detailed explanation of the process of Step S66 is omitted.

The controller 76 can control an air pressure of the tire 16C in accordance with a height of the seat post 48. For example, the controller 76 more reduces an air pressure of the tire 16C as a height of the seat post 48 is lower.

The controller 76 can determine whether or not a height of the seat post 48 is equal to or less than a predetermined height on the basis of an operation state of the fourth electric actuator 48B.

### Seventh Embodiment

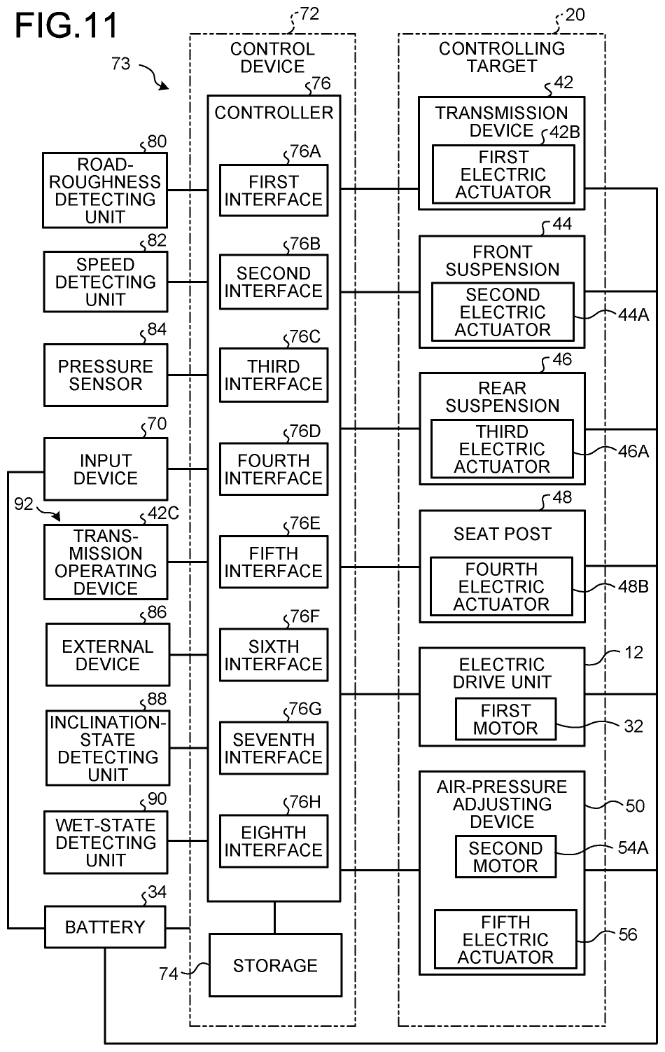

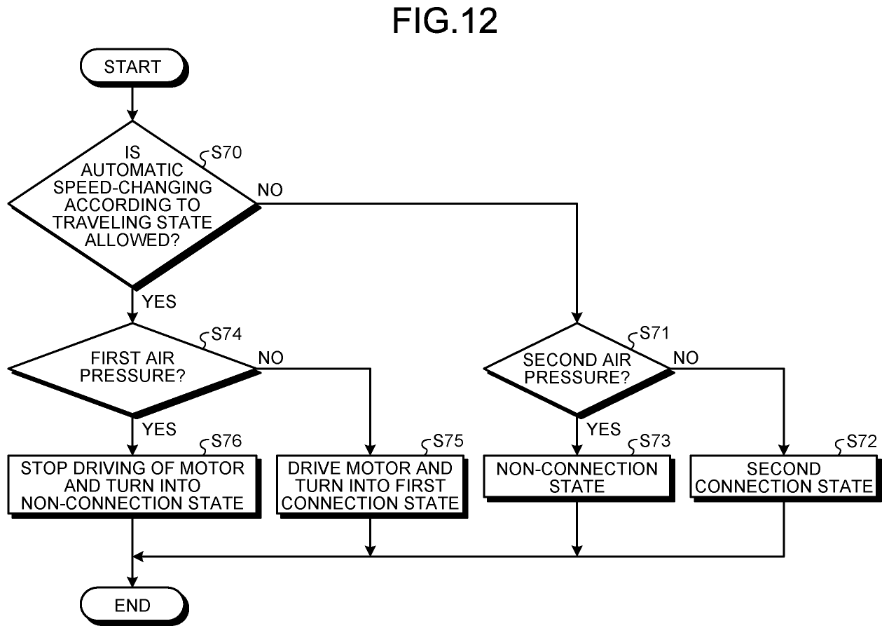

A part according to a seventh embodiment different from those according to the first embodiment and the fifth embodiment will be explained. The component is the transmission device 42 that changes a transmission ratio in accordance with a traveling speed of the human-powered vehicle 10. As illustrated in FIG. 11, the component-state detecting unit 92 is the transmission operating device 42C. A state of the transmission device 42 is changed by operation of a rider which is input into the transmission operating device 42C, for example. A state of the transmission device 42 is detected by the transmission operating device 42C that is the component-state detecting unit 92, for example. A state of the transmission device 42 can be detected by a sensor provided to the transmission device 42 or the like. An air-pressure control process according to the seventh embodiment will be explained with reference to FIG. 12.

In Step S70, the controller 76 determines whether or not an automatic change in a transmission ratio is allowed in accordance with a traveling state of the human-powered vehicle 10. The controller 76 determines whether or not a transmission mode of the transmission device 42 is a manual transmission mode. In a case where a transmission mode is a manual transmission mode, the controller 76 determines that an automatic change in a transmission ratio is not allowed in accordance with a traveling state of the human-powered vehicle 10. In a case where a transmission mode is an automatic transmission mode, the controller 76 determines that an automatic change in a transmission ratio is allowed in accordance with a traveling state of the human-powered vehicle 10.

In Step S70, in a case where determining that an automatic change in a transmission ratio is not allowed in accordance with a traveling state of the human-powered vehicle 10, the controller 76 shifts the processing to Step S71. In Step S71, the controller 76 determines whether or not an air pressure value of the tire 16C is the second air pressure value. As described above, the second air pressure value is a low air pressure value.

In Step S71, in a case where determining that an air pressure value of the tire 16C is not the second air pressure value, the controller 76 shifts the processing to Step S72. In other words, speed changing is in a state of manual speed changing, and further the tire 16C has a high air pressure. The process of Step S72 is equal to the process of Step S16 according to the first embodiment. In other words, the controller 76 causes the air-pressure adjusting device 50 to discharge air from the tire 16C so as to reduce an air pressure of the tire 16C. Thus, detailed explanation of the process of Step S72 is omitted. In a case where change in a transmission ratio is not allowed in accordance with a traveling state of the human-powered vehicle 10, the controller 76 reduces an air pressure of the tire 16C. In a case where change in a transmission ratio is not allowed in accordance with a traveling state of the human-powered vehicle 10, the controller 76 reduces an air pressure of the tire 16C to be lower than an air pressure of the tire 16C in a case where change in a transmission ratio is allowed in accordance with a traveling state of the human-powered vehicle 10. Changing in a transmission ratio in accordance with a traveling state of the human-powered vehicle 10 is automatic speed changing.

In Step S71, in a case where determining that an air pressure value of the tire 16C is the second air pressure value, the controller 76 shifts the processing to Step S73. In other words, speed changing is in a state of manual speed changing, and further the tire 16C has a low air pressure. The process of Step S73 is equal to the process of Step S17 according to the first embodiment. The controller 76 turns the solenoid valve 56 of the air-pressure adjusting device 50 into a non-connection state. Thus, detailed explanation of the process of Step S73 is omitted.

In Step S70, in a case where an automatic change in a transmission ratio is allowed in accordance with a traveling state of the human-powered vehicle 10, the controller 76 shifts the processing to Step S74. In Step S74, the controller 76 determines whether or not an air pressure value of the tire 16C is the first air pressure value. As described above, the first air pressure value is a high air pressure value.

In Step S74, in a case where determining that an air pressure value of the tire 16C is not the first air pressure value, the controller 76 shifts the processing to Step S75. In other words, speed changing is in a state of automatic speed changing, and further the tire 16C has a low air pressure. The process of Step S75 is equal to the process of Step S13 according to the first embodiment. In other words, the controller 76 causes the air-pressure adjusting device 50 to inject air into the tire 16C so as to increase an air pressure of the tire 16C. Thus, detailed explanation of the process of Step S75 is omitted. In a case where change in a transmission ratio is allowed in accordance with a traveling state of the human-powered vehicle 10, the controller 76 increases an air pressure of the tire 16C. In a case where change in a transmission ratio is allowed in accordance with a traveling state of the human-powered vehicle 10, the controller 76 increases an air pressure of the tire 16C to be higher than an air pressure of the tire 16C in a case where change in a transmission ratio is not allowed in accordance with a traveling state of the human-powered vehicle 10.

In Step S74, in a case where determining that an air pressure value of the tire 16C is the first air pressure value, the controller 76 shifts the processing to Step S76. In other words, speed changing is in a state of automatic speed changing, and further the tire 16C has a high air pressure. The process of Step S76 is equal to the process of Step S14 according to the first embodiment. The controller 76 stops driving of the second motor 54A of the air-pressure adjusting device 50 so as to turn the solenoid valve 56 into a non-connection state. Thus, detailed explanation of the process of Step S76 is omitted.

Eighth Embodiment

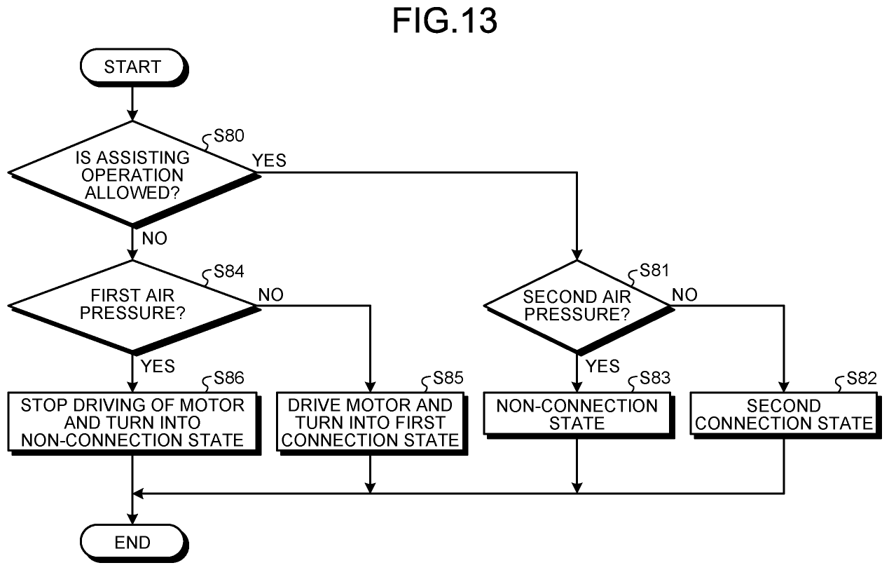

A part according to an eighth embodiment different from those according to the first embodiment and the fifth embodiment will be explained. The component is the electric drive unit 12 that assists propulsion of the human-powered vehicle 10 by using the first motor 32. As illustrated in FIG. 8, the component-state detecting unit 92 is the input device 70, for example. A state of the electric drive unit 12 is changed by operation of a rider which is input into the input device 70, for example. A state of the electric drive unit 12 is detected by the input device 70 that is the component-state detecting unit 92, for example. A state of the electric drive unit 12 can be detected by a sensor that is provided in the electric drive unit 12. An air-pressure control process according to the eighth embodiment will be explained with reference to FIG. 13.

In Step S80, the controller 76 determines whether or not an assisting operation by the electric drive unit 12 is allowed. The controller 76 determines whether or not an assisting operation by the electric drive unit 12 is allowed in the input device 70, for example.

In Step S80, in a case where determining that an assisting operation by the electric drive unit 12 is allowed, the controller 76 shifts the processing to Step S81. In Step S81, the controller 76 determines whether or not an air pressure value of the tire 16C is the second air pressure value. As described above, the second air pressure value is a low air pressure value.

In Step S81, in a case where determining that an air pressure value of the tire 16C is not the second air pressure value, the controller 76 shifts the processing to Step S82. In other words, an assisting operation is allowed, and further the tire 16C has a high air pressure. The process of Step S82 is equal to the process of Step S16 according to the first embodiment. In other words, the controller 76 causes the air-pressure adjusting device 50 to discharge air from the tire 16C so as to reduce an air pressure of the tire 16C. Thus, detailed explanation of the process of Step S82 is omitted. In a case where an assisting operation by the electric drive unit 12 is allowed, the controller 76 reduces an air pressure of the tire 16C. In a case where an assisting operation by the electric drive unit 12 is allowed, the controller 76 reduces an air pressure of the tire 16C to be lower than an air pressure of the tire 16C in a case where an assisting operation by the electric drive unit 12 is not allowed

In Step S81, in a case where determining that an air pressure value of the tire 16C is the second air pressure value, the controller 76 shifts the processing to Step S83. In other words, an assisting operation is allowed, and further the tire 16C is a low air pressure. The process of Step S83 is equal to the process of Step S17 according to the first embodiment. The controller 76 turns the solenoid valve 56 of the air-pressure adjusting device 50 into a non-connection state. Thus, detailed explanation of the process of Step S83 is omitted.

In Step S80, in a case where determining that an assisting operation by the electric drive unit 12 is not allowed, the controller 76 shifts the processing to Step S84. In Step S84, the controller 76 determines whether or not an air pressure value of the tire 16C is the first air pressure value. As described above, the first air pressure value is a high air pressure value.

In Step S84, in a case where determining that an air pressure value of the tire 16C is not the first air pressure value, the controller 76 shifts the processing to Step S85. In other words, an assisting operation is in a state of being not allowed, and further the tire 16C is a low air pressure. The process of Step S85 is equal to the process of Step S13 according to the first embodiment. In other words, the controller 76 causes the air-pressure adjusting device 50 to inject air into the tire 16C so as to increase an air pressure of the tire 16C. Thus, detailed explanation of the process of Step S85 is omitted. In a case where an assisting operation by the electric drive unit 12 is not allowed, the controller 76 increases an air pressure of the tire 16C. In a case where an assisting operation by the electric drive unit 12 is not allowed, the controller 76 increases an air pressure of the tire 16C to be higher than an air pressure of the tire 16C in a case where an assisting operation by the electric drive unit 12 is allowed.

In Step S84, in a case where determining that an air pressure value of the tire 16C is the first air pressure value, the controller 76 shifts the processing to Step S86. In other words, an assisting operation is in a state of being not allowed, and further the tire 16C is a high air pressure. The process of Step S86 is equal to the process of Step S14 according to the first embodiment. The controller 76 stops driving of the second motor 54A of the air-pressure adjusting device 50, and further turns the solenoid valve 56 into a non-connection state. Thus, detailed explanation of the process of Step S86 is omitted.

The controller 76 can control the air-pressure adjusting device 50 in accordance with a strength of assistance of the electric drive unit 12 so as to adjust an air pressure of the tire 16C. In a case where assistance of the electric drive unit 12 is small, the controller 76 increases an air pressure of the tire 16C. In a case where a state where a strength of assistance of the electric drive unit 12 is large is adjusted into a state where a strength of assistance of the electric drive unit 12 is small, the controller 76 increases an air pressure of the tire 16C. In a case where assistance by the electric drive unit 12 is large, the controller 76 reduces an air pressure of the tire 16C. In a case where a state where a strength of assistance by the electric drive unit 12 is small is adjusted into a state where a strength of assistance by the electric drive unit 12 is large, the controller 76 reduces an air pressure of the tire 16C.

### Ninth Embodiment

A part according to a ninth embodiment different from those according to the first to the eighth embodiments will be explained. The controller 76 controls an air pressure of the tire 16C provided to the human-powered vehicle 10 on the basis of detection result of at least one of a state of a road surface on which the human-powered vehicle 10 is traveling or will travel, a traveling state of the human-powered vehicle 10, and a state of a component of the human-powered vehicle 10. A state of a road surface includes at least one of a road-surface-roughness on which the human-powered vehicle 10 is traveling or will travel, a slope state related to an advancing direction of the human-powered vehicle 10, and a wet state of a road surface. The traveling state of the human-powered vehicle 10 includes a traveling speed of the human-powered vehicle 10. The state of the component of the human-powered vehicle 10 includes at least one of states of the suspensions 44 and 46, a height of the seat post 48, a transmission mode of the transmission device 42, and an assisting operation of the electric drive unit 12.

The controller 76 controls an air pressure of the tire 16C on the basis of a detection result having a high priority. Priorities of a road-surface-roughness, a slope state of a road surface, a wet state of a road surface, a traveling speed, a state of the suspensions 44 and 46, a height of the seat post 48, a transmission mode of the transmission device 42, and an assisting operation of the electric drive unit 12 are preset.

For example, the priorities are divided into a first group, a second group, and a third group. A priority of the first group is the highest. A priority of the second group is the second highest next to the first priority. A priority of the third group is the lowest.

The first group includes a road-surface-roughness, a slope state of a road surface, and a traveling speed. The second group includes a wet state of a road surface, states of the suspensions 44 and 46, and a height of the seat post 48. The third group includes a transmission mode of the transmission device 42 and an assisting operation of the electric drive unit 12.

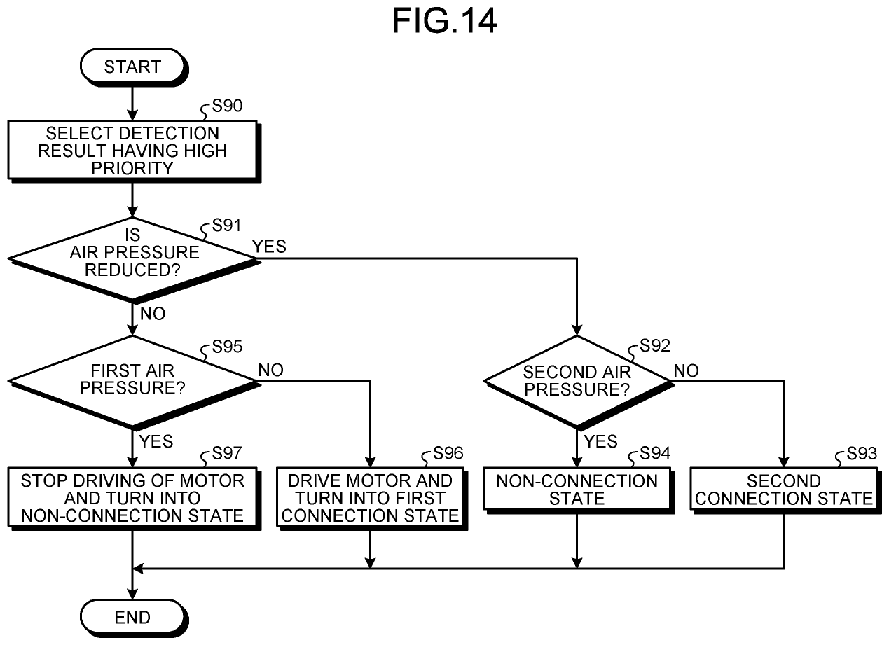

An air-pressure control process according to the ninth embodiment will be explained with reference to FIG. 14. In Step S90, the controller 76 selects a detection result having a high priority from among detection results, and shifts the processing to Step S91. In Step S91, the controller 76 determines whether or not the selected detection result is a result for reducing an air pressure. In Step S91, in a case where determining to be a result for reducing an air pressure, the controller 76 shifts the processing to Step S92.

In Step S92, the controller 76 determines whether or not an air pressure value is the second air pressure value. As described above, the second air pressure value is a low air pressure value. The second air pressure value can be set in accordance with the selected detection result.

In Step S92, in a case where determining that an air pressure value is not the second air pressure value, the controller 76 shifts the processing to Step S93. In other words, a detection result is in a state of a result for reducing an air pressure, and further the tire 16C is a high air pressure. The process of Step S93 is equal to the process of Step S16 according to the first embodiment. In other words, the controller 76 causes the air-pressure adjusting device 50 to discharge air from the tire 16C so as to reduce an air pressure of the tire 16C. Thus, detailed explanation of the process of Step S93 is omitted.

In Step S92, in a case where determining that an air pressure value is the second air pressure value, the controller 76 shifts the processing to Step S94. In other words, a detection result is in a state of a result for reducing an air pressure, and further the tire 16C has a low air pressure. The process of Step S94 is equal to the process of Step S17 according to the first embodiment. The controller 76 turns the solenoid valve 56 of the air-pressure adjusting device 50 into a non-connection state. Thus, detailed explanation of the process of Step S94 is omitted.

In Step S91, in a case where determining to be a result for increasing an air pressure, the controller 76 shifts the processing to Step S95. In other words, in Step S91, in a case where determining not to be a result for reducing an air pressure, the controller 76 shifts the processing to Step S95. In Step S95, the controller 76 determines whether or not an air pressure value is the first air pressure value. As described above, the first air pressure value is a high air pressure value. The first air pressure value can be set in accordance with a selected detection result.

In Step S95, in a case where determines that an air pressure value is not the first air pressure value, the controller 76 shifts the processing to Step S96. In other words, a detection result is in a state of a result for increasing an air pressure, and further the tire 16C has a low air pressure. The process of Step S96 is equal to the process of Step S13 according to the first embodiment. In other words, the controller 76 causes the air-pressure adjusting device 50 to inject air into the tire 16C so as to increase an air pressure of the tire 16C. Thus, detailed explanation of the process of Step S96 is omitted.

In Step S95, in a case where determining that an air pressure value is the first air pressure value, the controller 76 shifts the processing to Step S97. In other words, a detection result is in a state of a result for increasing an air pressure, and further the tire 16C has a high air pressure. The process of Step S97 is equal to the process of Step S14 according to the first embodiment. In other words, the controller 76 stops driving of the second motor 54A of the air-pressure adjusting device 50, and further turns the solenoid valve 56 into a non-connection state. Thus, detailed explanation of the process of Step S97 is omitted.

In each group, a priority can be further provided. For example, in the first group, a priority with respect to a road-surface-roughness is the highest. In the first group, a priority with respect to a slope state is the second highest next to the priority with respect to the road-surface-roughness. In the first group, a priority with respect to a traveling speed is the lowest. In the second group, a priority with respect to a state of wetness of a road surface is the highest. In the second group, a priority of states of the suspensions 44 and 46 is the second highest next to a priority with respect to a state of wetness of a road surface. In the second group, a priority with respect to a height of the seat post 48 is the lowest. In the third group, a priority with respect to a transmission mode in the transmission device 42 is higher than a priority with respect to an assisting operation in the electric drive unit 12.

The controller 76 can provides a point to each detection result so as to control an air pressure of the tire 16C on the basis of a total of points of the corresponding detection result. In other words, the controller 76 rounds up the detection results, and further calculates an air pressure of the tire 16C so as to control an air pressure of the tire 16C. In other words, the controller 76 compares each detection result so as to obtain an air pressure of the tire 16C, and further controls an air pressure of the tire 16C. For example, a point of a detection result for reducing an air pressure in each detection result is “−1”. A point of a detection result for increasing an air pressure in each detection result is “+1”. In a case where a total of points of each detection result is a negative value, the controller 76 reduces an air pressure of the tire 16C. In a case where a total of points of each detection result is a negative value, the controller 76 reduces an air pressure of the tire 16C to be lower than an air pressure of the tire 16C in a case where a total of points of the corresponding detection result is a positive value. In a case where a total of points of each detection result is a positive value, the controller 76 increases an air pressure of the tire 16C. In a case where a total of points of each detection result is a positive value, the controller 76 increases an air pressure of the tire 16C to be higher than an air pressure of the tire 16C in a case where a total of points of the corresponding detection result is a negative value.

Point(s) of each detection result can be weighed in accordance with a priority of the corresponding detection result. For example, point(s) of each detection result is multiplied by a factor according to a priority. A detection result having a high priority is multiplied by a large factor. In other words, a weight of a detection result having a high priority becomes large. The controller 76 controls an air pressure of the tire 16C on the basis of a total of points of a weighed detection result.

The controller 76 can control an air pressure of the tire 16C on the basis of a detection result for reducing an air pressure of the tire 16C in priority to a detection result for increasing an air pressure of the tire 16C.

In a case where each detection result includes a result for reducing an air pressure and a result for increasing an air pressure, it is possible that the controller 76 does not change an air pressure.

As described in the first to the ninth embodiments, the controller 76 controls an air pressure of the tire 16C provided to the human-powered vehicle 10 on the basis of at least one of a road-surface-roughness on which the human-powered vehicle 10 is traveling or will travel, a slope state related to an advancing direction of the human-powered vehicle 10, a wet state of a road surface, a traveling state of the human-powered vehicle 10, and a state of a component provided to the human-powered vehicle 10. Information related to at least one of a state of a road surface on which the human-powered vehicle 10 is traveling or will travel, a traveling state of the human-powered vehicle 10, and a state of a component of the human-powered vehicle 10 can be acquired by at least one of the input device 70 and the external device 86. As described below, for example, in a case where these pieces of information are information acquired from the Internet, these pieces of information are acquired by at least one of the input device 70 and the external device 86. For example, in the control device 72, at least one of the fourth interface 76D and the sixth interface 76F can be a detection unit that detects information related to at least one of a state of a road surface on which the human-powered vehicle 10 is traveling or will travel, a traveling state of the human-powered vehicle 10, and a state of a component of the human-powered vehicle 10. Similarly, each of the first interface 76A, the second interface 76B, the third interface 76C, the fifth interface 76E, the seventh interface 76G, and the eighth interface 76H can be a detection unit that detects information.

As described above, the air-pressure adjusting device 50 automatically executes intake or exhaust to the tire 16C provided in the human-powered vehicle 10 on the basis of detection result of at least one of a state of a road surface on which the human-powered vehicle 10 is traveling or will travel, a traveling state of the human-powered vehicle 10, and a state of a component of the human-powered vehicle 10. However, among items for determining intake or exhaust to the tire 16C, there presents an item by which a determination result can be obtained even in a case where the human-powered vehicle 10 is not traveling. For example, an item by which a determination result can be obtained even in a case where the human-powered vehicle 10 is not traveling is a state of a component of the human-powered vehicle 10. In many cases, a state of a road surface on which the human-powered vehicle 10 is traveling or will travel can be determined by using positional information of the human-powered vehicle 10 which is detected by a reception device of a satellite positioning system. In a state where the human-powered vehicle 10 is not traveling, a state of a road surface on which the human-powered vehicle 10 is traveling is a state of a road surface that will be traveled by the human-powered vehicle 10. A state of a road surface that will be traveled by the human-powered vehicle 10 can be determined by a route that will be traveled by the human-powered vehicle 10 and positional information of the human-powered vehicle 10. For example, in a case of a route having been already traveled, a result of roughness detected at the time can be used as a state of a road-surface-roughness. With respect to a traveling speed of the human-powered vehicle 10, the following is supposed. For example, in a case where change in a state of a road surface of a route that will be traveled is little, a traveling speed is supposed to be almost constant. That is a case where a road surface of a route that will be traveled is flat and paved, for example. In such a case, a traveling speed can be set before traveling. In other words, a traveling speed of the human-powered vehicle 10 can be set before traveling. For example, a traveling speed of the human-powered vehicle 10 is set via the input device 70, the external device 86, or the like. In these cases, a determination result can be obtained even in a case where the human-powered vehicle 10 is not traveling. The air-pressure adjusting device 50 is not always provided to the human-powered vehicle 10. In other words, for example, the air-pressure adjusting device 50 is a fixed-type device. For example, before traveling of the human-powered vehicle 10, an air pressure of the tire 10C can be adjusted from information obtained on the basis of a route that will be traveled. For example, before traveling of the human-powered vehicle 10, the air-pressure adjusting device 50 is capable of adjusting an air pressure of the tire 16C from information obtained on the basis of a state of a component of the human-powered vehicle 10.

In a state where the human-powered vehicle 10 is not traveling, for example, is before traveling, the air-pressure adjusting device 50 can acquire information related to at least one of a state of a road surface on which the human-powered vehicle 10 will travel, a traveling state of the human-powered vehicle 10, and a state of a component of the human-powered vehicle 10 so as to calculate an appropriate air pressure of the tire 16C. In other words, in a state where the human-powered vehicle 10 is not traveling, the air-pressure adjusting device 50 can acquire information related to at least one of a state of a road surface on which the human-powered vehicle 10 is traveling or will travel, a traveling state of the human-powered vehicle 10, and a state of a component of the human-powered vehicle 10, and further can calculate an adjustment value of an air pressure of the tire 16C so as to adjust an air pressure of the tire 16C. Herein, as described above, a state of a road surface on which the human-powered vehicle 10 is traveling or will travel can include at least a road-surface-roughness on which the human-powered vehicle 10 is traveling or will travel, a slope state related to an advancing direction of the human-powered vehicle 10, and a wet state of a road surface. As described above, a traveling state of the human-powered vehicle 10 can include a traveling speed of the human-powered vehicle 10. As described above, a state of a component of the human-powered vehicle 10 can include at least states of the suspensions 44 and 46, a state of the seat post 48, a state of the transmission device 42, and a state of the electric drive unit 12. In a state where the human-powered vehicle 10 is not traveling, the air-pressure adjusting device 50 automatically executes intake or exhaust to the tire 16C so as to obtain a calculated air pressure. At least one piece of information related to each state can be stored in the air-pressure adjusting device 50. At least one piece of information related to each state can be input into the air-pressure adjusting device 50. At least one piece of information related to each state can be acquired from the external device 86 or the human-powered vehicle 10. The air-pressure adjusting device 50 can acquire positional information of the air-pressure adjusting device 50 by using a reception device of a satellite positioning system. For example, map information can be stored in the air-pressure adjusting device 50. Map information can be acquired from the external device 86 by using the air-pressure adjusting device 50. A traveling route of the human-powered vehicle 10 can be acquired from the human-powered vehicle 10 or the external device 86. A traveling route of the human-powered vehicle 10 can be directly input into the air-pressure adjusting device 50. In a case where a traveling route of the human-powered vehicle 10 is input into the air-pressure adjusting device 50, the air-pressure adjusting device 50 can transmit the input traveling route to the control device 72 of the human-powered vehicle 10. Change in a state of a component of the human-powered vehicle 10 can be input into the air-pressure adjusting device 50. In other words, setting of a component of the human-powered vehicle 10 can be executed from the air-pressure adjusting device 50. In a case where change in a state of a component of the human-powered vehicle 10 is input into the air-pressure adjusting device 50, the air-pressure adjusting device 50 can transmit the change in the input state of the component of the human-powered vehicle 10 to the control device 72 of the human-powered vehicle 10.

The air-pressure adjusting device 50 can be configured to be detachable from the human-powered vehicle 10. For example, the air-pressure adjusting device 50 and the valve stem 16D of the wheel 16 are connected by the output pipe 60 to be detachable. The air-pressure adjusting device 50 adjusts an air pressure of the tire 16C before traveling of the human-powered vehicle 10. The output pipe 60 is separated from the valve stem 16D of the tire 16C after an air pressure is adjusted. Communication between the control device 72 and the air-pressure adjusting device 50 included in the human-powered vehicle 10 is executed in a wired or wireless manner.

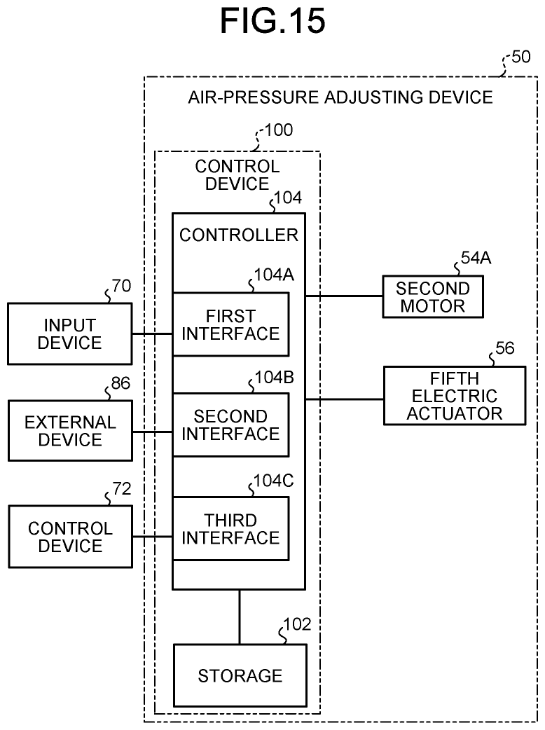

For example, as illustrated in FIG. 15, the air-pressure adjusting device 50 includes a human-powered vehicle control device 100. Hereinafter, the human-powered vehicle control device 100 will be simply referred to as the control device 100. The control device 100 includes a storage 102 and an electronic controller 104. The storage 74 is any computer storage device or any non-transitory computer-readable medium with the sole exception of a transitory, propagating signal. For example, the storage 102 includes a non-volatile memory and a volatile memory. The storage 102 stores therein software for controlling the air-pressure adjusting device 50.

The electronic controller 104 is a computer, and will be hereinafter referred to as the controller 104. For example, the controller 104 includes at least one calculation device (processors) such as a CPU and an MPU. The controller 104 can include a plurality of calculation devices. When the controller 104 includes a plurality of calculation devices, the plurality of calculation devices can be arranged in positions that are separated from each other. The controller 104 is configured such that the calculation device executes a program stored in the ROM by using the RAM as a work region, for example, so as to control the air-pressure adjusting device 50.

The controller 104 is connected to the input device 70, the external device 86, and the control device 72 of the human-powered vehicle 10 via at least one of an electric cable and a wireless communication device. The controller 104 is connected to a battery via an electric cable. The controller 104 can be connected to at least one of the input device 70, the external device 86, and the control device 72 of the human-powered vehicle 10 via at least one of an electric cable and a wireless communication device.

Preferably, the controller 104 includes a first interface 104A. The first interface 104A is configured to receive information that is received by the input device 70. Preferably, the controller 104 includes a second interface 104B. The second interface 104B is configured to receive information that is transmitted from the external device 86. Preferably, the controller 104 includes a third interface 104C. The third interface 104C is configured to receive information that is transmitted from the control device 72. As described above, for example, at least one information of a state of a road surface on which the human-powered vehicle 10 is traveling or will travel, a traveling state of the human-powered vehicle 10, and a state of a component of the human-powered vehicle 10 can be acquired from the control device 72 of the human-powered vehicle 10. In other words, in the air-pressure adjusting device 50, for example, each of the first interface 104A to the third interface 104C is a detection unit that detects information related to at least one of a state of a road surface on which the human-powered vehicle 10 is traveling, a traveling state of the human-powered vehicle 10, and a state of a component of the human-powered vehicle 10.

Each of the first interface 104A to the third interface 104C includes at least one of a cable connecting port and a wireless communication device, for example. The wireless communication device includes a short-range distance wireless communication unit, for example. In a case where an electric cable is connected to each of the first interface 104A to the third interface 104C, an electric cable can be fixed thereto while omitting a cable connecting port.

In a state where the human-powered vehicle 10 is not traveling, the controller 104 acquires information related to at least one of a state of a road surface on which the human-powered vehicle 10 will travel, a traveling state of the human-powered vehicle 10, and a state of a component of the human-powered vehicle 10. The controller 104 calculates an adjustment value of an air pressure of the tire 16C on the basis of the acquired information. The controller 104 adjusts an air pressure of the tire 16C so as to obtain the calculated adjustment value. Although the control device 72 and the air-pressure adjusting device 50 are shown separately in this embodiment, the air-pressure adjusting device 50 may be included in the control device 72. The control device 72 may be included in the air-pressure adjusting device 50.

For example, in order to obtain a more appropriate air pressure of the tire 10C from the detection result, a machine-learned estimation model can be used by using the detection result and a value of an air pressure of the tire 16C as teacher data. The detection result is at least one of a state of a road surface on which the human-powered vehicle 10 is traveling, a traveling state of the human-powered vehicle 10, and a state of a component of the human-powered vehicle 10. For example, the detection result is at least one of a road-surface-roughness, a slope state related to an advancing direction of the human-powered vehicle 10, and a traveling speed of the human-powered vehicle 10. These detection results are items whose priorities are high. For example, the detection result can be at least one of states of the suspensions 44 and 46, a height of the seat post 48, a state of a transmission mode of the transmission device 42, and a state of an assisting operation by the electric drive unit 12. These detection results are states of components of the human-powered vehicle 10. In other words, the controller 76 calculates an adjustment value of an air pressure of the tire 16C by using an estimation model on the basis of a detection result of at least one of a road-surface-roughness on which the human-powered vehicle 10 is traveling, a slope state related to an advancing direction of the human-powered vehicle 10, a wet state of a road surface, a traveling state of the human-powered vehicle 10, and a state of a component provided to the human-powered vehicle 10. The controller 76 controls an air pressure of the tire 16C on the basis of the calculated adjustment value. The controller 76 calculates an adjustment value of an air pressure of the tire 16C by using an estimation model on the basis of a detection result of at least one of a state of a road surface on which the human-powered vehicle 10 is traveling, a traveling state of the human-powered vehicle 10, and a state of a component of the human-powered vehicle 10. The controller 76 controls an air pressure of the tire 16C on the basis of the calculated adjustment value. In a case where controlling an air pressure of the tire 16C, the controller 76 can calculate an adjustment value of an air pressure of the tire 16C by using an estimation model on the basis of a priority of a detection result.

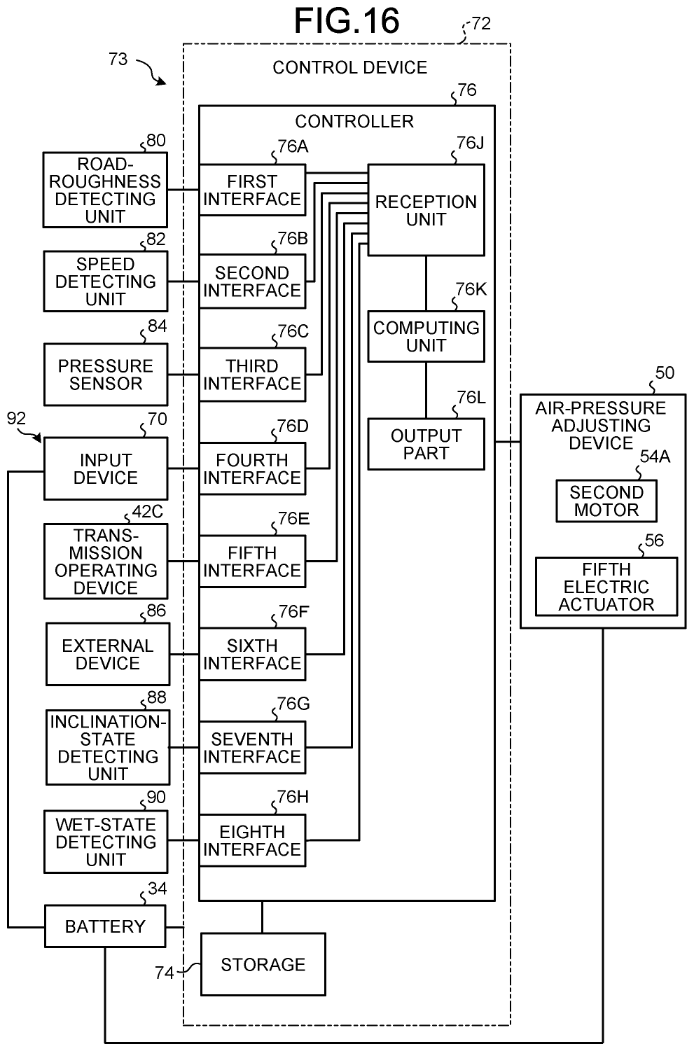

A detection result and an air pressure of the tire 16C corresponding to the detection result are stored in a storing means. An air pressure of the tire 16C corresponding to a detection result is an air pressure of the tire 16C which is adjusted on the basis of the detection result. The storing means is the storage 74, for example. The storing means can be an external storing means via the Internet, for example. Teacher data includes detection result and an air pressure of the tire 16C which is adjusted on the basis of the detection result. An estimation model receives a detection result, and further outputs an estimated adjustment value of an air pressure of the tire 16C. As illustrated in FIG. 16, the controller 76 of the control device 72 includes a reception unit 76J, a computing unit 76K, and an output part 76L. In FIG. 16, a part of configuration other than that related to function for controlling an air pressure of the tire 16C is omitted. The control device 72 receives a detection result. The control device 72 receives the detection result by the reception unit 76J. The reception unit 76J receives a detection result of a road-surface-roughness via the first interface 76A. The reception unit 76J receives a detection result of a traveling speed via the second interface 76B. The reception unit 76J receives a detection result of an air pressure of the tire 16C via the third interface 76C. The reception unit 76J receives a detection result of a state of a component via the fourth interface 76D. The reception unit 76J receives a detection result of a state of the transmission operating device 42C via the fifth interface 76E. The reception unit 76J receives information that is transmitted from the external device 86 via the sixth interface 76F. The reception unit 76J receives a detection result of a slope state via the seventh interface 76G. The reception unit 76J receives a detection result of a wet state via the eighth interface 76H. For example, the input device 70 is the component-state detecting unit 92 that detects a state of a component. The control device 72 calculates an adjustment value of an air pressure of the tire 16C by using an estimation model. The control device 72 causes the computing unit 76K to calculate an adjustment value of an air pressure of the tire 16C by using an estimation model. The control device 72 outputs a calculated adjustment value of an air pressure of the tire 16C to the air-pressure adjusting device 50. The control device 72 causes the output part 76L to output information related to an adjustment value of an air pressure of the tire 16C to the air-pressure adjusting device 50. The model can be provided to the external device 86. For example, generation of the model can be executed by using a technology related to machine learning of unsupervised learning. For example, generation of the model can be executed by using a technology of deep learning. For example, generation of the model can be executed by appropriately using a technology of various kinds of deep learning such as a Deep Neural Network (DNN), a Recurrent Neural Network (RNN), and a Convolutional Neural Network (CNN). The above-mentioned description related to generation of a model is merely one example, and generation of a model can be executed by using a learning method that is appropriately selected in accordance with an available detection result. The process using a model can be executed by the air-pressure adjusting device 50. In other words, the air-pressure adjusting device 50 can store a model, and further can calculate an appropriate air pressure of the tire 16C on the basis of at least one detection result of a state of a road surface on which the human-powered vehicle 10 is traveling, a traveling state of the human-powered vehicle 10, and a state of a component of the human-powered vehicle 10.

The air-pressure adjusting device 50 can automatically execute intake or exhaust to the tire 16C so as to obtain the calculated air pressure. The air-pressure adjusting device 50 can acquire information related to an appropriate air pressure of the tire 16C which is calculated by the external device 86, and further can automatically execute intake or exhaust to the tire 16C so as to obtain the acquired air pressure.

Control of an air pressure of the tire 16C using an estimation model can be executed by the air-pressure adjusting device 50. In a state where the human-powered vehicle 10 is not traveling, the air-pressure adjusting device 50 calculates an adjustment value of an air pressure of the tire 16C by using an estimation model on the basis of a state of a road surface on which the human-powered vehicle 10 will travel, a traveling speed of the human-powered vehicle 10, and information related to at least one state of a component of the human-powered vehicle 10. The air-pressure adjusting device 50 controls an air pressure of the tire 16C on the basis of the calculated adjustment value. In this case, the controller 104 can take a configuration that is similar to that of the controller 76 illustrated in FIG. 16. In other words, the controller 104 can include a reception unit, a computing unit, and an output part.

The expression of “at least one” described in this specification means “one or more” desired choices. The expression of “at least one” described in this specification means, as one example, “one choice alone” or “both of two choices” when there preset two choices. The expression of “at least one” described in this specification means, as another example, “one choice alone” or “combination of two or more arbitrary choices” when the number of choices is equal to or more than three.

While certain embodiment and modification of the present invention have been described, the description thereof is not intended to limit the embodiments. The constituting elements described herein include elements easily achieved by one skilled in the art, elements being substantially the same as the constituting elements, and elements within the scope of equivalents of the constituting elements. The constituting elements described herein can be combined in an appropriate manner. Furthermore, various omissions, substitutions and changes in the constituting elements can be made without departing from the spirit of the embodiment.

What is claimed is:

1. A control device for a human-powered vehicle, the control device comprising:
an electronic controller configured to control an air pressure of a tire provided to a human-powered vehicle based on at least one of a roughness of a road surface on which the human-powered vehicle is traveling or will travel, a slope state related to an advancing direction of the human-powered vehicle, a wet state of the road surface, a traveling state of the human-powered vehicle, and a state of a component mounted on the human-powered vehicle.

2. The control device according to claim 1, wherein
the electronic controller is further configured to control the air pressure of the tire based on a detection result of a road-surface-roughness detecting unit configured to detect the roughness of the road surface on which the human-powered vehicle is traveling or will travel.

3. The control device according to claim 1, wherein
the electronic controller is further configured to control the air pressure of the tire based on a detection result of a slope-state detecting unit configured to detect a slope state related to an advancing direction of the human-powered vehicle.

4. The control device according to claim 1, wherein
the electronic controller is further configured to control the air pressure of the tire based on a detection result of a wet-state detecting unit configured to detect a wet state of a road surface.

5. The control device according to claim 1, wherein
the electronic controller is further configured to control the air pressure of the tire based on a detection result of a speed detecting unit configured to detect a traveling speed of the human-powered vehicle.

6. The control device according to claim 1, wherein
the electronic controller is further configured to control the air pressure of the tire based on a detection result of a component-state detecting unit configured to detect a state of a component mounted on the human-powered vehicle.

7. The control device according to claim 6, wherein
the component includes a suspension that is attached to a frame to reduce an impact applied from a road surface.

8. The control device according to claim 6, wherein
the component includes a seat post that is capable of adjusting a height of a saddle of the human-powered vehicle.

9. The control device according to claim 6, wherein
the component includes a transmission device configured to change a transmission ratio in accordance with a traveling state of the human-powered vehicle.

10. The control device according to claim 6, wherein
the component includes an electric drive unit configured to assist in propulsion of the human-powered vehicle by using a motor.

11. A control device for a human-powered vehicle, the control device comprising:
an electronic controller configured to control an air pressure of a tire provided to a human-powered vehicle based on at least one detection result of a state of a road surface on which the human-powered vehicle is traveling or will travel, a traveling state of the human-powered vehicle, and a state of a component of the human-powered vehicle,
the electronic controller being further configured to control the air pressure of the tire based on a detection result having a high priority.

12. A control device for a human-powered vehicle, the control device comprising:
an electronic controller that is configured to control an air pressure of a tire provided to a human-powered vehicle based on at least one detection result of a state of a road surface on which the human-powered vehicle is traveling or will travel, a traveling state of the human-powered vehicle, and a state of a component of the human-powered vehicle,
the electronic controller being further configured to control the air pressure of the tire in accordance with a detection result in which the air pressure of the tire is reduced in priority to a detection result in which the air pressure of the tire is increased.

13. The control device according to claim 1, wherein
the electronic controller is further configured to:
calculate an adjustment value of the air pressure of the tire by using an estimation model based on at least one of a roughness of a road surface on which the human-powered vehicle is traveling or will travel, a slope state related to an advancing direction of the human-powered vehicle, a wet state of the road surface, a traveling state of the human-powered vehicle, and a state of the component mounted on the human-powered vehicle; and
control the air pressure of the tire based on the calculated adjustment value.

14. The control device according to claim 11, wherein the electronic controller is further configured to:
calculate an adjustment value of the air pressure of the tire by using an estimation model, based on the detection result; and
control the air pressure of the tire based on the calculated adjustment value.

15. A control system comprising the control device according to claim 1, the control system further comprising:
an air-pressure adjusting device configured to adjust the air pressure of the tire,
in a state where the human-powered vehicle is not traveling, the electronic controller being further configured to:
acquire information related to at least one of a state of the road surface on which the human-powered vehicle will travel, a traveling state of the human-powered vehicle, and a state of the component mounted on the human-powered vehicle;
calculate an adjustment value of the air pressure of the tire; and
adjust the air pressure of the tire.

16. An air-pressure adjusting device that is configured to adjust an air pressure of a tire of a human-powered vehicle, the air-pressure adjusting device comprising:
a control device configured to control the air pressure of the tire,
in a state where the human-powered vehicle is not traveling, the control device is configured to:
acquire information related to at least one of a state of a road surface on which the human-powered vehicle will travel, a traveling state of the human-powered vehicle, and a state of a component mounted on the human-powered vehicle;
calculate an adjustment value of the air pressure of the tire; and
adjust the air pressure of the tire.

17. The air-pressure adjusting device according to claim 16, wherein
the air-pressure adjusting device is configured to be detachably provided to the human-powered vehicle.

18. The air-pressure adjusting device according to claim 16, wherein
the control device is further configured to:
calculate the adjustment value of the air pressure of the tire by using an estimation model based on the at least one piece of information; and
control the air pressure of the tire based on the adjustment value that was calculated.
